(19) United States
(12) Patent Application Publication
(10) Pub. No.: US 2015/0169597 A1
(43) Pub. Date: Jun. 18, 2015

(54) Methods and Systems for Locating Items and Determining Item Locations

(71) Applicant: QUALCOMM Incorporated, San Diego, CA (US)

(72) Inventors: Stephen William EDGE, Escondido, CA (US); Hui CHAO, Santa Clara, CA (US); Saumitra Mohan DAS, Santa Clara, CA (US)

(21) Appl. No.: 14/569,389

(22) Filed: Dec. 12, 2014

Related U.S. Application Data
(60) Provisional application No. 61/917,121, filed on Dec. 17, 2013.

(51) Int. Cl. G06F 17/30

(52) U.S. Cl. CPC G06F 17/3087

(57) ABSTRACT

Various techniques for locating an item are presented. A first location history may be received that is indicative of a first plurality of locations visited by a first mobile device. A first indication of a type of item being located by a user of the first mobile device may also be received. A second location history indicative of a second plurality of locations visited by a second mobile device may be received. A second indication of the type of item being located by a user of the second mobile device may also be received. A location of the type of item may be determined based on the first location history, the second location history and optionally the first and second indications. The determined location of the type of item may be subsequently provided to a mobile device to assist a user of the mobile device to locate the type of item. Provision of location history information and receipt of information to locate an item may occur in combination on a mobile device.

### CROSS REFERENCES TO RELATED APPLICATIONS

This application claims priority to co-pending U.S. Application No. 61/917,121, entitled “Methods and Systems for Locating Items and Determining Item Locations,” filed on Dec. 17, 2013, the entire disclosure of which is hereby incorporated by reference in its entirety for all purposes.

### BACKGROUND

Locating an item in a shop, such as a department store, supermarket or warehouse type store, can be a time-consuming and frustrating activity. Typical ways of finding an item include finding and asking a store clerk or finding and reviewing a store directory. Frequently, both clerks and store directories are few and far between. Further, a store directory will not always list all items and a store clerk will not always know where every item can be found. Moreover, a person looking for many items may not plan or be able to plan any particular efficient order in which to acquire items within a store. Without knowing such an order, a person may acquire items in an inefficient (e.g., arbitrary) order, involving backtracking within the store and wasted time.

### SUMMARY

An example method for locating an item, according to the disclosure, includes receiving, by a computer system, a first location history indicative of a first plurality of locations visited by a first mobile device, receiving, by the computer system, from the first mobile device, a first indication of a first type of item being found, and receiving, by the computer system, a second location history indicative of a second plurality of locations visited by a second mobile device. The method further includes receiving, by the computer system, from the second mobile device, a second indication of the first type of item being found, and determining, by the computer system, a location of the first type of item based on the first plurality of locations and the second plurality of locations.

The example method can include one or more of the following features. The respective first and second indications can each include a respective first and second time of finding of the first type of item, and determining the location of the first type of item can be based additionally on the first and second times of finding. The respective first and second pluralities of locations can each include at least one of locations visited by the respective first and second mobile device within a threshold period of time from the respective first and second times of finding, or locations and times at which the respective first and second mobile device was determined by the respective first and second mobile device to be stationary, substantially stationary, or making movements consistent with acquiring the first type of item. The method can include weighting each location of the first plurality of locations based on the time elapsing between the first mobile device being present at the location and the first time of finding, wherein the weight of a location increases as the time elapsing is reduced, weighting each location of the second plurality of locations based on the time elapsing between the second mobile device being present at the location and the second time of finding, wherein the weight of a location increases as the time elapsing is reduced, and determining the location of the item based on the weighting. The first indication can include a location in the first plurality of locations corresponding to finding the first type of item, and the second indication can include a location in the second plurality of locations corresponding to finding the first type of item. The method may include determining, by the computer system, that the first location history and the second location history are associated with a particular store, and/or creating, by the computer system, information that associates the first type of item to a location on a map of an interior layout of the particular store based on the determined location of the first type of item. The method may include receiving a request for the location of the first type of item and providing the location of the first type of item, wherein the provided location is the determined location. The provided location can include a reference location and a location relative to the reference location. The method may include determining a route to retrieve the first type of item, and providing the route. The method may include determining, by the computer system, a location of a second type of item, determining, by the computer system, the first type of item and the second type of item are part of a category, and determining an area corresponding to the category, based on the location of the first type of item and the location of the second type of item. The first location history can include a reference location, wherein the reference location corresponds to at least one of the location of the first type of item, a location of a second type of item or a known location. Determining the location of the first type of item can be based in part on the reference location.

An example method for locating an item at a mobile device, according to the description, can include determining a location history for the mobile device indicative of a plurality of locations visited by the mobile device, receiving a first indication that a first type of item has been found by a user of the mobile device, and sending the location history and a second indication that the first type of item was found to a computer system.

The example method can include one or more of the following features. The second indication can include a time the first indication was received. The plurality of locations can include at least one of locations visited by the mobile device within a threshold period of time from the time the first indication was received, or locations and times at which the mobile device was determined by the mobile device to be stationary, substantially stationary, or making movements consistent with acquiring the first type of item. The method can include weighting each location of the plurality of locations based on the time elapsing between the mobile device being present at the location and the time the first indication was received, wherein the weight of a location increases as the time elapsing is reduced, and including the weight of each location in the location history sent to the computer system. The second indication can include a location in the plurality of locations corresponding to a location of the mobile device when the first indication was received. The method can include sending an indication of a particular store to the computer system. The method can include sending a request for the location of the first type of item to the computer system, receiving at least one of a location of the first type of item or a route for the first type of item from the computer system, and providing directions to the user of the mobile device based on at least one of the location and the route. The location of the first type of item can include a reference location and a location relative to the reference location. The location history may comprise a reference location, wherein the reference location corresponds to at least one of the location of the mobile device when the first indication is received, the location of the mobile device when an indication that a second type of item was found is received or an indication that a known location was found is received.

An example server, according to the disclosure, can include a communication interface configured to receive a first location history indicative of a first plurality of locations visited by a first mobile device, receive, from the first mobile device, a first indication of a first type of item being found, receive a second location history indicative of a second plurality of locations visited by a second mobile device, and receive, from the second mobile device, a second indication of the first type of item being found. The server can further include a processor communicatively coupled with the communication interface and configured to determine a location of the first type of item based on the first plurality of locations and the second plurality of locations.

The server can include one or more of the following features. The processor can be configured to determine the location of the first type of item based additionally on first and second times of finding the first type of item, when the first and second times of finding are included in the respective first and second indications. The processor can be configured to weight each location of the first plurality of locations based on the time elapsing between the first mobile device being present at the location and the first time of finding, where the weight of a location increases as the time elapsing is reduced, weight each location of the second plurality of locations based on the time elapsing between the second mobile device being present at the location and the second time of finding, where the weight of a location increases as the time elapsing is reduced, and determine the location of the item based on the weighting. The processor can be configured to determine that the first location history and the second location history are associated with a particular store. The communication interface can be further configured to receive a request for the location of the first type of item, and the processing unit it can be configured to cause the server to provide the location of the first type of item, wherein the provided location is the determined location.

An example mobile device, according to the description, can include a processor configured to determine a location history for the mobile device indicative of a plurality of locations visited by the mobile device, a user interface configured to receive a first indication that a first type of item has been found by a user of the mobile device, and a communication interface configured to send the location history and a second indication that the first type of item was found to a computer system.

The mobile device can include one or more of the following features. The processor can be configured to weight each location of the plurality of locations based on the time elapsing between the mobile device being present at the location and the time the first indication was received, where the weight of a location increases as the time elapsing is reduced, and include the weight of each location in the location history sent to the computer system. The processor can be configured to cause the mobile device to send, via the communication interface, an indication of a particular store to the computer system. The processor can be configured to cause the mobile device to send, via the communication interface, a request for the location of the first type of item to the computer system, receive, via the communication interface, at least one of a location of the first type of item or a route for the first type of item from the computer system, and provide directions to the user of the mobile device based on at least one of the location and the route.

An example apparatus, according to the disclosure, can include means for receiving a first location history indicative of a first plurality of locations visited by a first mobile device, means for receiving, from the first mobile device, a first indication of a first type of item being found, and means for receiving a second location history indicative of a second plurality of locations visited by a second mobile device. The apparatus can further include means for receiving, from the second mobile device, a second indication of the first type of item being found, and means for determining a location of the first type of item based on the first plurality of locations and the second plurality of locations.

The apparatus can include one or more of the following features. The means for determining the location of the first type of item can be configured to base the determination on first and second times of finding the first type of item when the first and second times of finding are included in the respective first and second indications. The apparatus can further include means for weighting each location of the first plurality of locations based on the time elapsing between the first mobile device being present at the location and the first time of finding, where the weight of a location increases as the time elapsing is reduced, means for weighting each location of the second plurality of locations based on the time elapsing between the second mobile device being present at the location and the second time of finding, where the weight of a location increases as the time elapsing is reduced, and means for determining the location of the item based on the weighting. The apparatus can further include means for determining that the first location history and the second location history are associated with a particular store. The apparatus can further include means for receiving a request for the location of the first type of item, and means for providing the location of the first type of item, wherein the provided location is the determined location.

Another example apparatus, according to the disclosure, includes means for determining a location history for the mobile device indicative of a plurality of locations visited by the mobile device, means for receiving a first indication that a first type of item has been found by a user of the mobile device, and means for sending the location history and a second indication that the first type of item was found to a computer system.

The apparatus can include one or more of the following features. The apparatus can include means for weighting each location of the plurality of locations based on the time elapsing between the mobile device being present at the location and the time the first indication was received, where the weight of a location increases as the time elapsing is reduced, and means for including the weight of each location in the location history sent to the computer system. The apparatus can include means for sending an indication of a particular store to the computer system. The apparatus can include means for sending a request for the location of the first type of item to the computer system, receiving at least one of a location of the first type of item or a route for the first type of item from the computer system, and providing directions to the user of the mobile device based on at least one of the location and the route.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a system for locating items in a shopping store.

FIG. 2 illustrates a first location history overlaid on a store map.

FIG. 3 illustrates a second location history overlaid on the store map.

FIG. 4 illustrates the first location history and the second location history having locations in common on the store map.

FIG. 5 illustrates an embodiment of a mobile application for indicating located items and/or receiving indications of locations of items.

FIG. 6 illustrates an embodiment of a system for determining the locations of items.

FIG. 7 illustrates an embodiment of a mobile device for acquiring a location history, indicating located items, and/or receiving indications of locations of items.

FIG. 8 illustrates an embodiment of a method for determining a location of an item.

FIG. 9 illustrates an embodiment of a method for providing a location of an item.

FIG. 10 illustrates an embodiment of a method for creating, updating or adding to a map of a store or other place or area using multiple location histories.

FIG. 11 illustrates an embodiment of a method for determining category locations based on item locations.

FIG. 12 represents an example of a computer system.

FIG. 13 illustrates an embodiment of a method for locating an item at a mobile device.

### DETAILED DESCRIPTION

In order to locate items in a store or other place or area (e.g., a museum, art gallery, shopping mall, warehouse, school, library, office, home), a “self-learning” location-based system may be used in conjunction with mobile devices (e.g., cellular phones, smart phones, tablet computers). Devices and techniques detailed herein are applicable to finding a specific item, such as a particular painting in an art gallery, and a type of item, such as a type of merchandise, in a store. It should be understood that unless noted otherwise, references to locating an “item” are also applicable to a “type of item”. Similarly, unless noted otherwise, references to locating a “type of item” are also applicable to locating a specific “item”.

The techniques described herein may assist a user to locate an item or a place or some other object or entity and may in addition be used to create and update data that can be used later to assist other users to locate items, places or other objects or entities. In some cases, both activities may occur in combination whereby a user is assisted to locate an item, place or other object or entity and data is created or updated, for example based upon whether the item, place, object or other entity is successfully located and where it is located, to assist other users to locate the same item, place, object or other entity at a later time or times.

The systems and techniques described herein may be implemented by one or more mobile devices such as by one or more operating systems for the mobile devices and/or by one or more applications (Apps) on the mobile devices. The systems and techniques may be further implemented by one or more servers or other computer based systems that can be accessed by mobile devices that support the systems and techniques. In some embodiments, there may be few or no servers and mobile devices may exchange data among themselves (e.g. using peer to peer communication techniques) to support the systems and techniques described herein. The collection or set of entities that support the systems and techniques in the context of providing a common service to one or more users (e.g. a common service that can locate types of items in different shopping stores) is referred to herein as a “locating system”. A user of such a locating system may be a shopper but could also be any other user who needs directions to find items or places. For example, a user of a locating system could be an employee of a company (e.g. for a locating system that can help locate items and places related to a business or company), a member of the public (e.g. for a locating system that can help locate places and buildings in a city or town), a traveler (e.g. for a locating system that help locate gates at an airport or platforms at a railway station), etc. A locating system may comprise (i) individual applications acting autonomously on mobile devices, (ii) different applications on mobile devices acting in coordination with one another (e.g., by sharing data via peer-to-peer signaling), (iii) different applications on mobile devices acting in coordination with one or more remote servers (e.g., accessed via the Internet) or (iv) remote servers supporting direct access from users via browsers on the users' mobile devices. Some combination of these different types of locating system may also be possible as well as other ways of supporting access to a locating system from users' mobile devices.

In describing the systems and techniques that may be implemented by a locating system to enable users to locate items, places and other points or objects of interest, an example of users in a shopping store will be assumed where users may be assisted by the locating system to locate items and types of items in the store and where locations of items and types of items found by users (with or without assistance from the locating system) may be used by the locating system to better determine the locations of items and type of items. It should be understood that similar principles can be applied in other situations, such as finding specific items or types of items in a warehouse, house, office, museum, restaurant, hotel, airport, hospital, etc. The systems and techniques as described herein can also be used to find amenities, exhibits, rooms, and other places in any small or large area such as a museum, art gallery, airport, amusement park, office, school, college, hospital, town or city and more generally can be used to find locations in the absence of other reliable external data. For example, the systems and techniques may be used to locate shops, restaurants, office buildings, hotels and other places in a town or city when such information is otherwise lacking. Furthermore, an Internet service, mapping company, or social network could make use of these systems and techniques to gather data from its users concerning locations of places and items and provide the data to other users.

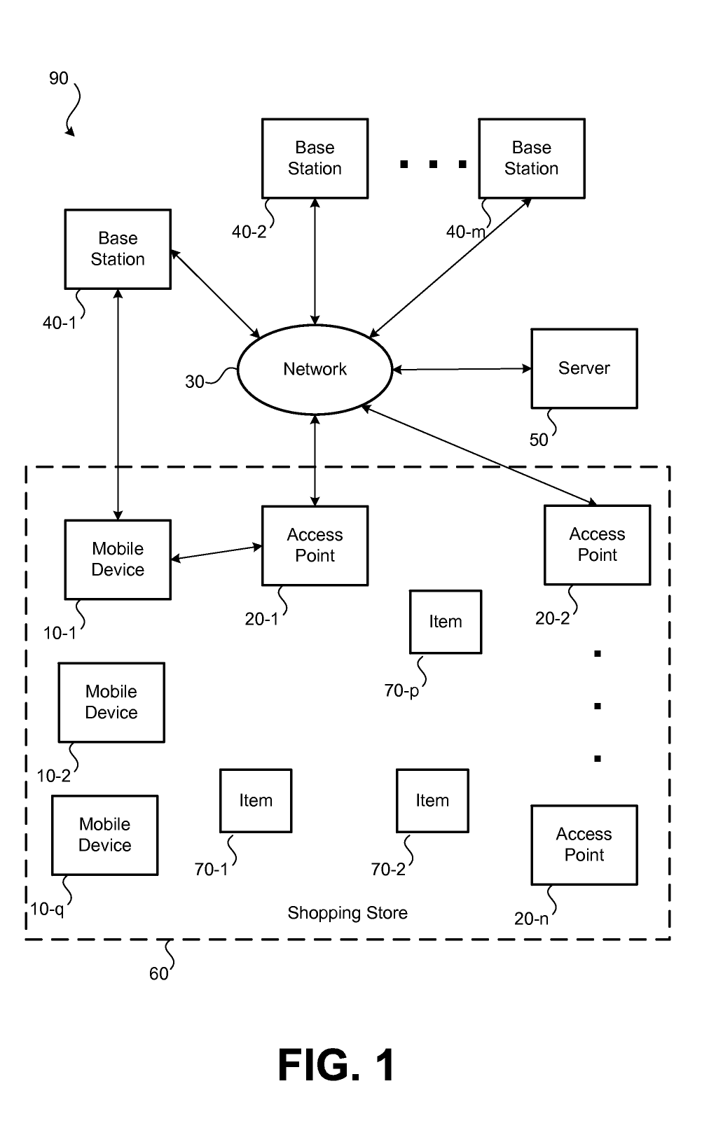

FIG. 1 illustrates an example scenario 90 wherein the users of a number of mobile devices 10-1, 10-2 . . . 10-q would each like to locate one or more of a number of items 70-1, 70-2 . . . 70-p that are situated at different locations in a shopping store 60. In this example, a number of access points (APs) 20-1, 20-2, . . . 20-n are present inside the store 60 that provide short range radio communication using WiFi, Bluetooth®, Long Term Evolution (LTE) or some other wireless technology with a short range capability or short range limitation. Some of the access points (for example, 20-1 and 20-2) have links to a local serving network 30 which may be a cellular network that supports wireless communication using Global System for Mobile Communications (GSM), Wideband Code Division Multiple Access (WCDMA), Long Term Evolution (LTE) or Code Division Multiple Access 2000 (CDMA2000), to name just a few examples. The network 30 has a number of base stations 40-1, 40-2, . . . 40-m nearby to the shopping store 60 which provide wireless coverage to some or all parts of the shopping store 60. A server 50 is attached to the network 30 or may be communicatively reached from the network 30—e.g. via the Internet. Each of the mobile devices 10 may support a common locating system in association with one other and/or in association with server 50 and possibly other servers not shown in FIG. 1. When the mobile devices 10 support a common locating system in association with server 50, the mobile devices 10 may communicate with server 50 via network 30 and/or via one or more of APs 20 that connect to network 30 (e.g. APs 20-1 and 20-2) and/or via one or more of base stations 40. Any mobile device 10 may also make use of wireless signals received from one or more of base stations 40 and/or one or more of APs 20 to help determine the location of the mobile device 10. For example, a mobile device 10 may measure the signal strength, signal timing or a round trip signal propagation time for one or more of APs 20 and/or one or more of base stations 40 and determine a location for the mobile device 10 using the resulting measurements and assistance data received from server 50 that may include the location coordinates and transmission characteristics (e.g. transmission power, transmission timing) for one or more of APs 20 and/or one or more of base stations 40. The location determination may make use of position methods such as Advanced Forward Link Trilateration (AFLT), Observed Time Difference Of Arrival (OTDOA), Enhanced cell ID (E-CID), Wireless Local Area Network (WLAN) Positioning and Short Range Node (SRN) positioning that have been standardized by standards bodies such as the 3^{rd} Generation Partnership Project (3GPP), the 3^{rd} Generation Partnership Project 2 (3GPP2) and the Open Mobile Alliance (OMA).

Each mobile device 10 may be a cellular phone, smartphone, tablet, laptop, wearable (e.g. smartwatch) or any other device that may be carried by a user and is enabled to communicate with other entities (e.g. other mobile devices 10 or server 50) by wireless means. A mobile device 10 may be referred to as a user equipment (UE), mobile station, mobile terminal, terminal, Secure User Plane Location (SUPL) Enabled Terminal (SET) or by some other name. Server 50 may be part of a network such as network 30 or may be attached to a network such as network 30 and may in some cases support SUPL and contain or be associated with a SUPL Location Platform (SLP). There may be more than one server 50 supporting a particular locating system. For example, multiple servers 50 may be deployed to support the same locating system in different geographic areas, to provide load sharing in the same geographic areas and/or to provide redundancy and backup of data. Data related to supporting a locating system may be communicated between mobile devices 10, between a mobile device 10 and a server 50 and/or between different servers 50. Data may be sent from a first mobile device 10 serving some user to a second mobile device 10 and/or to a server 50 in order to request data concerning locations of items 70 within a store 60 and/or in order to provide (e.g. crowd source) new data concerning discovered locations of items 70 in a store 60 that the first mobile device 10 may have obtained or inferred when helping a user to locate items 70 in the store 60. Data may be sent from a server 50 to a first mobile device or from a second mobile device 10 to a first mobile device 10 in order to provide data regarding known locations of items 70 in a store 60. Data may be sent from a first server 50 to a second server 50 in order distribute data obtained (e.g. through crowdsourcing) by the first server 50 from one or more mobile devices 10 concerning locations of items 70 in a store 60. Data that is sent from a first mobile device 10 to a second mobile device 10 or from a one first mobile device to a server 50 may include a location history for the user of the first mobile device associated with the user attempting to find items in a store or other place or area. Such types of data transfer are examples of how a locating system may exchange data among its component entities and are not to be considered limiting. Data communication between components of a locating system (such as between mobile devices 10 and/or servers 50) may make use of data transport by networks such as network 30 and may use protocols based on the IETF Internet Protocol (IP)—e.g. may make use of User Datagram Protocol (UDP) over IP and/or Transmission Control Protocol (TCP) over IP as just two examples.

FIG. 1 provides one example where a locating system may be used employing techniques described herein. It is introduced to clarify the descriptions of these techniques with reference to a particular example but should in no way be assumed to limit the scope of these techniques.

A locating system, such as that exemplified in FIG. 1, may both assist users to locate items and create and update data to enable users to locate items. The former activity will be referred to herein as “location assistance” and the latter activity will be referred to as “location self learning”. As mentioned previously both activities may occur in combination.

### Location Self Learning

Location self learning may be supported by gathering location data from one or more mobile devices 10 that may include the locations of various items 70 within a store 60. The location of where any item 70 (which may be a specific brand of item, a category of items (e.g., tablet computers), or related types of items (e.g., laptop computers, tablet covers, tablet chargers)) is located may be crowd-sourced from location data sourced from multiple mobile devices 10. The user of any mobile device 10 may provide an indication (e.g., list) of one or more items 70 the user desires to acquire while at the store 60 to the mobile device 10 (e.g., to an application on the mobile device 10 that supports a locating system). After a particular item 70 has been located (e.g., seen, taken in hand, placed in the user's physical shopping cart) by the user, the user may indicate that the item has been located to the mobile device 10. A user indicating that an item 70 has been located may typically imply that the item 70 was a most recently located item 70 and that the user is standing nearby to where the item 70 was located (e.g., on a certain shelf in a store) but this may not always apply. For instance, a user may indicate to a mobile device 10 (e.g., to an application on the mobile device) that an item 70 has been located some time before the user is nearby to the item 70 (e.g., if the user sees the item 70 at a distance before approaching the item 70 to place in a shopping cart or to view the item 70 up close). Similarly, a user may indicate to a mobile device 10 that an item 70 was located some time after the user leaves the vicinity of where the item 70 was located (e.g., if the user places an item 70 in a shopping cart or looks at the item 70 up close and then moves away and then indicates that the item was found some time later). The location of the user (e.g., as determined by a positioning capability of the mobile device 10) at the moment in time when a user indicates to the mobile device 10 that an item 70 was found may thus sometimes be an accurate indication of where the item 70 is located and, thus, where any other items 70 of the same type may be located, but may sometimes not be an accurate indication if the user had indicated the item 70 was found some time before or some time after the user was next to or near the item 70.

By using location data gathered from one or more mobile devices 10 associated with one or more users who have found the same item 70 or a common type of item 70 in a common general location (e.g., at some common point along the same aisle in the same store 60), the location of the type of item 70 may be determined. For instance, if multiple different users have indicated that the same type of item 70 was found, the locations of these users at the time the type of item 70 was indicated as found may be compared. Alternatively or in addition, if, in multiple visits to the same store 60, a single user has indicated the same type of item 70 was found on each visit, the locations of the same user (when finding the same type of item 70) for these different visits may be compared. The locations may all be different or at least all slightly different. However, the locations may be combined in different ways to yield a probable location or a more reliable and accurate location for the type of item 70. For example, all the locations may be averaged, such as by obtaining an average x coordinate and an average y coordinate or an average latitude and an average longitude. Alternatively, locations that are distant from most of the other locations (e.g., 10 meters or more distant from at least some percentage, such as 50%, of other locations determined for the item) may be disregarded and locations that are nearby to most other locations (e.g., within 10 meters of at least some percentage, such as 50%, of locations) may be averaged.

In another aspect, a mobile device 10 (or an application on a mobile device 10) may record the location history of a user both prior to and subsequent to the user indicating that an item 70 was located. Sensors on the mobile device 10 may determine when a user was possibly next to the item 70 (e.g., possibly placing the item 70 in a shopping cart or possibly viewing details of the items 70 such as a price tag or other aspects of the item). For example, inertial sensors on the mobile device 10 (e.g., accelerometer, gyroscope, magnetometer) may be able to determine whether a user is stationary and/or moving in a manner consistent with placing an item 70 in a shopping cart or examining or verifying an item 70 and may store and/or flag the associated location of the user in a user location history. Locations of a user both prior to and following an indication by the user that an item 70 was located that are consistent with the user being stationary and/or placing an item 70 in a shopping cart or shopping basket (or examining or verifying an item 70) may then be considered as candidate locations for the item 70. The set of these candidate locations for many users who have found the same type of item 70 in the same general location (e.g., the same store 60) may then be compared. The location of the type of item 70 may then be inferred from any candidate location that is common to the largest number of users. Since the locations of users, when nearby or next to the type of item 70 will not usually be exactly the same (e.g., due to location measurement errors and the possibility of the type of item 70 having a small range of nearby locations), the location of the type of item 70 may instead be inferred from the largest set of candidate locations that can be obtained from the different user location histories, where the set contains at most one candidate location from each user and all the candidate locations in the set are nearby to one another (e.g., within 10 meters of each other). The average location for the candidate locations comprising this largest set may then be taken as the location of the type of item 70. In performing this determination, the location history of each user may be restricted to candidate locations that occur near to when (e.g., within 10 to 30 seconds to when) the user indicted the type of item 70 was found in order to eliminate other common locations that the users may share such as locations around the entry and exit for the store 60 or locations of check out cash registers in the store 60.

Once the location of a type of item 70 has been determined using information provided by users (e.g., as previously described), the location may be provided in response to a location request for this type of item 70 from a user. For instance, if a user indicates that the user desires to find the type of item 70, the user, via a mobile device 10, may be provided with an indication of the location of the item 70. For instance, a map may be provided to the user that indicates where within the store 60 the type of item 70 is located. In other embodiments, an aisle number and, possibly, aisle side (or other form of location identifier), may be indicated. In some embodiments, directions may be given to the user (e.g., “proceed down the current aisle away from the store entrance, make a left, proceed to the next aisle, turn left and proceed 15 feet”).

Location histories from different users in conjunction with indications of when users have indicated that types of items 70 have been found may be crowd sourced by mobile devices 10 that support the same locating system to a server 50 that supports the locating system in order to determine a location of different types of items 70. In particular, the location histories of multiple mobile devices 10 associated with users who acquire a common type of item 70 may be used to determine a location as to where a store 60 keeps that type of item 70. Once the location of a type of item 70 has been determined by the locating system (e.g. by a server 50 supporting the locating system), additional data may be collected to confirm and/or refine the location of the type of item 70. For example, a server 50 may periodically determine the location of the same item 70 using location history information and indications of where and when in the location histories the item 70 was found that are crowd sourced by mobile devices 10 at different times. The determined locations for the item 70 may be compared to any previous location stored for the item 70 to determine whether the location may need to be updated or extended (e.g. for an item 70 that appears at several locations in a store 60). As a store 60 may occasionally relocate types of items 70; such periodic location determination may be used to determine to where the type of item 70 has been relocated. Such an arrangement may also be used to determine when a type of item 70 can be found in multiple locations within a store 60 and/or when a user mistakenly provides an indication that an item 70 was found.

### Examples of Location Self Learning

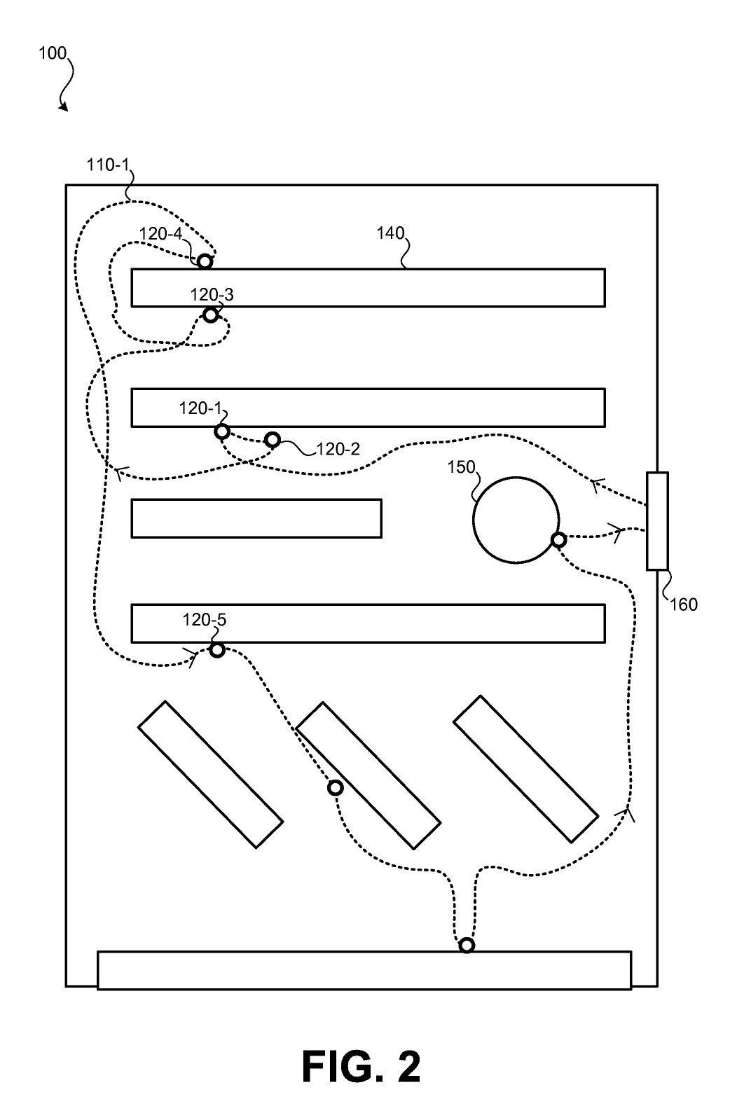

FIG. 2 illustrates an example embodiment 100 of a first location history for a user of a mobile device 10 overlaid on a map for the store 60 in FIG. 1. The first location history 110-1, represented by a dotted line, indicates where the mobile device 10 for the user (and thus normally the user) was located within the store 60 at different times while the user was in the store 60. The arrows on the dotted line further represent the direction of movement along the location history 110-1 by the mobile device 10. Location history 110-1 represents a route taken within the store 60 by the user possessing the mobile device 10. Location history 110-1 may have been captured by the mobile device 10 of the user as the user shopped within the store 60 and/or may have been captured by a server 50 based on location information (e.g. location measurements, location estimates) provided by mobile device 10 to the server 50. Location history 110-1 may be captured as a continuous route through the store 60 and may in that case be represented as an image (e.g. the dotted line in FIG. 2), as a sequence of line segments or by some other means. Alternatively, location history 110-1 may be captured as a series of separate locations obtained at separate times (e.g. at 10 seconds intervals and/or whenever the mobile device 10 detected that the user was stationary). Location history 110-1 may also comprise the time or range of time (or date and time or range of time) at which the mobile device 10 was at each location or at some locations in the location history 110-1. Each of locations 120 may indicate a location along location history 110-1 at which the mobile device 10 (and thus typically the user) was at least approximately stationary for a threshold period of time and/or the mobile device 10 otherwise detected that a user may have acquired an item 70. The locations 120-1, 120-2, 120-3, 120-4, and 120-5 in FIG. 2 may thus represent locations at each of which a user of the mobile device 10 could have located and acquired an item 70 in the store 60. In the example of FIG. 2, it is further assumed that locations 120-1, 120-2, 120-3, 120-4, and 120-5 represent all the locations at which the user of the mobile device 10 could have located and acquired an item 70 in the store 60, but this is purely to simplify the description and does not limit the systems and techniques described herein which may be applied to any number of such locations.

At various times while location history 110-1 is being created, the user may provide an indication to the user's mobile device 10 (e.g. to an application on the mobile device supporting a locating system) that an item has been found (also referred to as “located,” or, if taken into possession, “acquired”). For instance, while at location 120-3, the user of mobile device 10 may indicate that an item 70 has been found. That item 70 may be located at location 120-3, but as previously described could instead be located at any of locations 120-1, 120-2, 120-4 or 120-5. These five locations thus represent candidate locations for the location of the particular item 70 that the user indicated as having been found when the user was at location 120-3. In the illustrated embodiment, locations 120-1 and 120-2 were visited prior to location 120-3 and locations 120-4 and 120-5 were visited after location 120-3. An indication of at least a portion of location history 110-1 (e.g., the portion of location history 110-1 that has occurred up until the time the user indicates the item 70 was found) may be associated with the item 70 indicated by the user as located. This information may be provided to the server 50 by the mobile device 10 (e.g., after the user has left the store) for use in determining the location of the item 70. In some embodiments, as described later herein, the mobile device 10 may operate in a standalone mode and locally use the location history information along with the indication of the item 70.

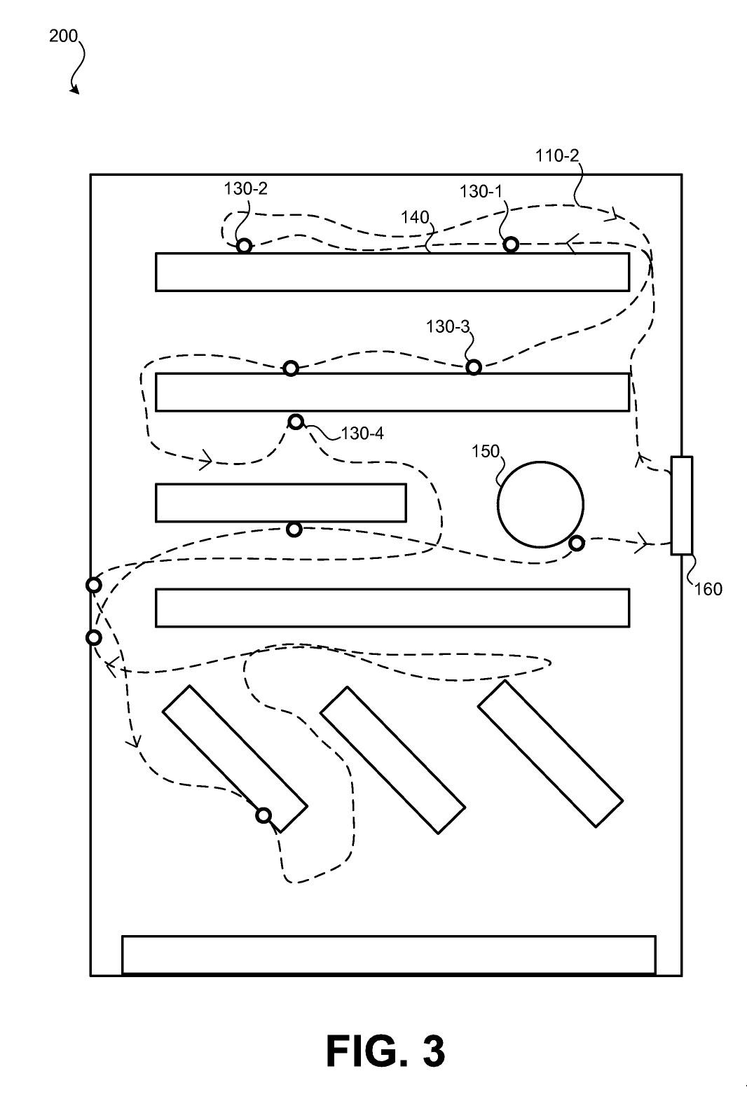

FIG. 3 illustrates an embodiment 200 of a second location history overlaid on the same store map (for the store 60) as embodiment 100. Embodiment 200 may represent a separate visit by the same user and/or same mobile device 10 to the same store 60 at some different time or may represent a visit by a different user (with a different mobile device 10) to the same store 60. The second location history 110-2, represented by a dashed line, indicates where a mobile device 10 was located within the store 60. The arrows on the dashed line further represent the direction of movement along the location history 110-2 by the mobile device 10. Location history 110-2 represents a route taken within the store by the user possessing the mobile device 10. Location history 110-2 may have been captured by the mobile device 10 of the user as the user shopped within the store or may be captured by a server 50 based on location information (e.g. location measurements, location estimates) supplied by the mobile device 10 to the server 50. Location history 110-2 may be captured as a continuous route through the store. Alternatively, location history 110-2 may be captured as a series of locations where the mobile device 10 paused for at least a threshold period of time. Location history may be represented in the same way as location history 110-1 (e.g. as an image of a continuous route, as a sequence of line segments or as a series of separate locations) and may further comprise the time, date and time or range of time at which the mobile device 10 was at each location or at some locations. In embodiment 200, similarly to embodiment 100, the user of mobile device 10 may indicate that a type of item 70 has been found when the mobile device 10 is at location 130-3. Each of locations 130 may indicate a location along location history 110-2 at which the mobile device was at least approximately stationary for a threshold period of time and/or the mobile device otherwise detected that a user may have acquired the item 70. A locating system may therefore assume that the user could have acquired the item 70 at any of locations 130-1, 130-2, 130-3, and 130-4. Other locations along location history 110-2 may also be possible locations at which the user acquired the item 70 in the store 60 though in this example, it is assumed that the candidate locations are just those shown, namely 130-1. 130-2, 130-3 and 130-4. In the illustrated embodiment, locations 130-1 and 130-2 were visited prior to location 130-3. Location 130-4 is visited after location 130-3. An indication of at least a portion of location history 110-2 (e.g., the portion of location history 110-2 that has occurred up until the time that the user indicates the item 70 was found) may be associated with the item 70 indicated by the user as located. This information may be provided to a remote server 50 (e.g., after the user has left the store 60) for use in determining the location of the item 70.

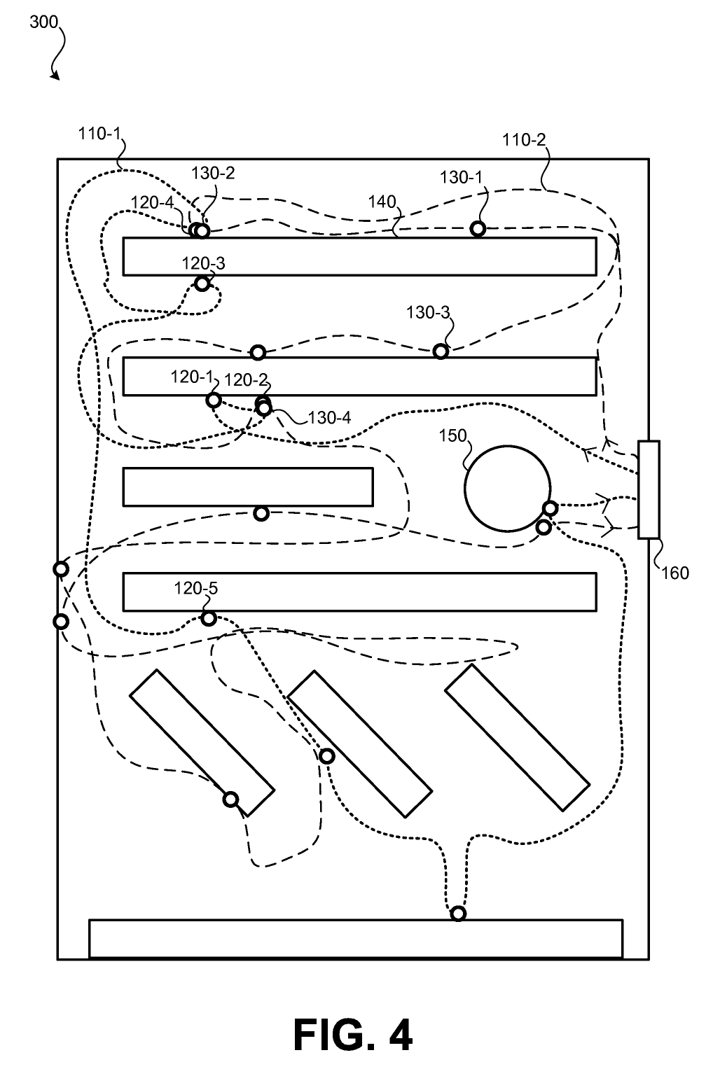

FIG. 4 illustrates an embodiment 300 of the location histories of FIGS. 2 and 3 overlaid on the store map for store 60 together. As can be seen from the overlay of FIG. 4, multiple locations along location histories 110 exist where the users of location history 110-1 and location history 110-2 paused at similar locations. For example, location 120-4 and location 130-2 are approximately the same. Similarly, location 120-2 and 130-4 are approximately the same.

If in providing a listing of items to be located, the user associated with location history 110-1 indicated that the same item 70 (or same type of item 70) had been acquired as the user associated with location history 110-2, it may be likely that the item 70 (or type of item 70) is located in the vicinity of locations 120-4 and 130-2 or in the vicinity of locations 120-2 and 130-4, because both of these pairs of locations were effectively visited in each location history. If the user associated with location history 110-1 indicated that the same item 70 was found after visiting location 120-3 but before visiting location 120-5, this may be indicative that the same item 70 is likely to be located in the vicinity of location 120-4. If the user associated with location history 110-2 further indicated that the same item 70 was located sometime after visiting location 130-1 and sometime before visiting location 130-3, this may be indicative that the same item 70 is located at or in the vicinity of location 130-2. The coincidence of locations 120-4 and 130-2 may then be used by a locating system (e.g. a server 50 or mobile device 10) as further evidence that the same item 70 is located in the vicinity of locations 120-4 and 130-2—e.g. at a location midway between these two locations.

The above example is simple in that it involves an analysis of common locations for only two location histories applied to one item that has been acquired in common by two users. It should be understood that hundreds or thousands of location histories may be used in combination with listings of multiple common items to determine likely locations of items 70 within some area such as a store 60. However, the above detailed technique of using approximately common locations, indications of the same item, and received indications of an item being found by a user may be extrapolated to use data collected from multiple users and associated mobile devices to determine locations for one or more common items. For instance, location history data in conjunction with indications of common items (or common types of items) being found or acquired by many (e.g., hundreds or thousands) of users may be used by a locating system to pinpoint the location of each item (or each type of item) with high precision. Specific embodiments that may enable this are described next and in some cases are related to the simple example in FIGS. 2-4.

Location Assistance Combined with Location Self Learning

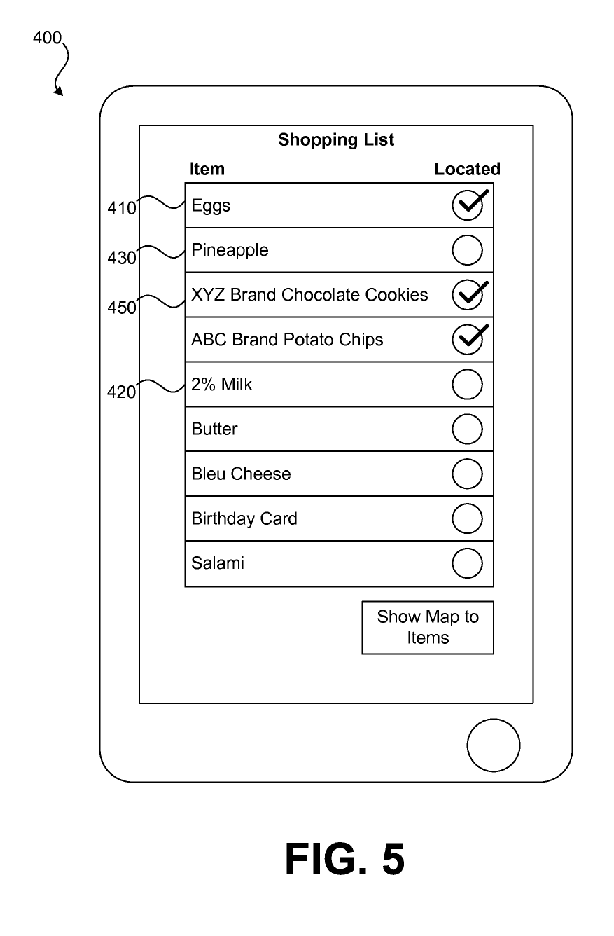

In some embodiments, a user may enter indications of desired items to an application being executed by a mobile device 10 where the application supports some or all of the functions of a locating system. FIG. 5 illustrates an embodiment 400 of a mobile application for indicating located items and/or receiving indications of locations of items. The user may enter a single item desired to be found, may enter multiple items, or may enter all items desired to be found (for instance, the user may enter his or her shopping list for a store 60 that the user is about to visit). In the example in FIG. 5, it is assumed that a user provides a complete or partial list of food items to be found in a supermarket or grocery and that the locating system (e.g. an application on the user's mobile device 10) keeps track of which items the user claims have been located and which items remain to be located. The user may or may not provide an explicit indication of a specific store 60 (e.g. specific supermarket or grocery) from which the items will be acquired. In the absence of an explicit indication, an application on a mobile device 10 or a website (e.g. hosted on a server 50) with which the application is interacting could assume that a user is referring to finding items close by to the user's current location—e.g., inside any store 60 within which the user is currently located or the nearest relevant store 60 nearby (e.g., a clothing store may be ignored if a user enters food items). In another aspect, an application and a user may first agree on the general or specific area within which items will be found—e.g., an application could detect the presence of the user inside a particular store 60 and ask the user to verify the store 60 before proceeding to provide directions to items that a user wishes to find. Alternatively, a user could enter the name and/or part or all of the address of a store 60 (e.g. such as “store XYZ on road ABC in city PQR”) and the application may then confirm whether the store 60 is recognized and can be supported with regard to locating items. It should be noted that a user “finding” an item 70 in a store 60 may be synonymous with one or more of the user “locating” the item 70, “acquiring” the item 70 (e.g., placing the item in a shopping cart), “confirming the presence” of the item 70 (e.g., in order to have the item 70 delivered if it is large or to determine details of the item 70 such as price and suitability), “verifying” or “examining” the item 70 (e.g. to help decide whether to buy the item 70), and generally moving near to or next to the item 70 such that the user's location may be an accurate representation of the item 70's location.

If the user enters multiple items to an application on the user's mobile device, such as exemplified in FIG. 5, and the locations of at least some of the items are stored by the locating system (e.g., by the application on the mobile device 10 or by a server 50 with which the application may be in communication), the entered items may be presented to the user by the mobile device 10 in an efficient order in which the user should obtain the items. For instance, the order may minimize or decrease an overall walking distance by the user to find items within the store 60. The order may also or instead prioritize items (by listing them early on in the order) that: (i) are of high (or low) monetary value, (ii) are known (e.g., from previous user behavior) to be of high value to the user, (iii) are light in weight or non-bulky (e.g., to reduce the time that a user may need to carry or otherwise transport heavy or bulky items) or (iv) do not require refrigeration (e.g., with cold items listed to be acquired towards the end of a user's shopping trip). User preferences may also be taken into account, such as that all meats and dairy should be left for the end of a shopping trip. These factors may be combined and weighted. For instance, price, size, weight, refrigeration and overall walking distance may each be a factor in determining the order in which an item should be acquired. These characteristics of items may be known to the locating system due to previous input by a user (or by multiple users) or due to input by the designer of the locating system. The ordering may be determined before a user has arrived at a store 60 if the user specifies which store 60 will be visited in advance. If not, the list may be ordered based on which store 60 a user is in proximity to or is within. In some cases, a list may not be created and instead a user may enter each item to be found one at a time—e.g., where each item is entered after a previous item has been found.

Upon arrival at a store 60, the user may select a first item 70 to find, such as eggs 410. Alternatively, the locating system may present the user with some efficient order (e.g. as illustrated in FIG. 5 and as described earlier) in which a list of items 70 will be found and allow the user to confirm that the user is ready to find the first item 70 on the list. In response to the user selection or confirmation of the first item 70 to be found, the locating system provides directions. The directions may include turn-by-turn directions to where the item 70 is located and/or may include a map indicative of the location of the item 70. A map or directions may only be provided if the location of the item 70 within the store 60 is known by the locating system. If the locating system does not have a location of the item 70 stored, no directions to the item 70 may be provided. In some embodiments, directions may be provided to a category associated with the item 70. For instance, the locating system may not know where mayonnaise is within a particular store 60, but may have a stored location for condiments, which could represent the general category of mayonnaise.

When or after the user has found and/or acquired an item 70, the user may provide an “item found” indication to the user's mobile device. In the illustrated embodiment of FIG. 5, a checkmark is placed next to the item; such an embodiment is merely exemplary. Throughout the time the user is within a store 60, a location history of the user's mobile device 10 may be determined (e.g., via GPS, detection and measurement by the mobile device of WLAN and/or Bluetooth (BT) access points (APs) 20 at known locations nearby to the user, detection and measurement of signals from nearby base stations 40, use of inertial sensors on the mobile device 10, etc.). Once an item 70 has been indicated by the user as found, the item 70 may be assumed by the locating system to have been actually found at some point in the location history up to and including the user's current location when indicating “item found” or may be assumed to be about to be found by the user a short time later on the location history (e.g., if a user indicates “item found” on sighting an item that the user is still approaching). As previously described for the examples of FIGS. 2-4, the location of the found item may be associated with any point in the user's location history including points that occur both prior to and subsequent to the location of the user when indicating the item was found. Moreover, points within the location history that occur nearer to the time when the user indicated the item was found may be considered by the locating system to be more likely to be associated with the location of the type of item than points that occur further away in time. Furthermore, points on the location history where the user is detected to be stationary or nearly stationary for at least a threshold period of time (e.g. 5 seconds) and/or where the user is detected to be making movements (e.g. as determined by inertial sensors on the mobile device 10) that are consistent with picking up an item, examining an item and/or placing an item in a shopping cart may be considered to be more likely locations of an item 70 that a user indicates as having been found than other locations where the user is moving and/or not making movements associated with finding an item. Once an item 70 has been indicated as found by a user, the user and the locating system may agree on the next item 70 to be found. For example, the user may explicitly indicate the next item or the system may proceed to the next item on a pre-agreed list. For example, in FIG. 5, after the user has indicated that eggs 410 were found in a store 60, the locating system (e.g. an application on the user's mobile device 10) and the user may agree that the next item to be found is pineapple 430.

A user may be permitted to provide “skip item” indications, “cancel item” indications and “item not found” indications via the user's mobile device, which may allow the user to proceed with finding another item and/or indicate that an item may not be in a store (e.g., not stocked or out of stock). For example, in FIG. 5, a user may decide not to buy pineapple 430 (e.g. because the price is high) and may indicate that this item is to be skipped and may agree with the locating system that the next item to be found is XYZ brand Chocolate Cookies 450.

A locating system could require that a user be standing in front of an item 70 before the user indicates that an item 70 has been found or acquired; however this may only be reasonable in a standalone mode (as described later) and may require additional concentration from users. Therefore, it would be more advantageous that a user could indicate that an item 70 has been found or acquired any time shortly after or shortly before the user has found the item 70. The locating system could infer a set of possible locations for any item 70 based on a user's location history prior to and subsequent to indicating that a particular item 70 has been found as previously described in association with the examples in FIGS. 2-4. The set of locations could be discrete (e.g. containing locations where a user was temporarily at least approximately stationary for a threshold period of time) or could be continuous, such as a path through a store indicative of where the user travelled for a period of time before and/or after the user indicated that an item 70 has been found. For a particular item 70, probabilities may be assigned to each location. The probability assigned to any location may be dependent on the time interval between the user being at the location and the user indicating that an item 70 has been found—the shorter the time, the higher the probability may be that the item 70 is located at that location. The possible locations and their assigned probabilities may be crowd sourced to a server 50 for multiple users (and/or multiple shopping trips by the same user) to determine likely locations of items 70 within the store 60. In some cases, the probabilities may be assigned by a server 50 based on information provided by a mobile device for a particular user location history. For example, a mobile device may provide a location history for a user to a server 50 where the location history comprises a set of locations where the user was at least temporarily stationary or otherwise detected to be possibly acquiring an item together with the time or times at which the user was at each location and the time and location of the user when the user indicated an item was found. In this example the server 50 may use the provided information to determine probabilities for the provided set of locations that are associated with the item being found at each of these locations. The possible locations of a common type of item 70 crowd sourced for many users together with the corresponding probabilities that each location is the correct location for the type of item 70 may be combined (e.g. by a server 50) to yield a single location for the item 70 using weighted averaging or by finding a small area containing the greatest weighted sum of possible locations.

Embodiment 400 in FIG. 5 indicates a mobile application on a mobile device 10 displaying a list of items to be found as previously described. The items may be communicated by the mobile application to a server 50 of the locating system to determine if the locations of the items are stored (assuming the store 60 that the user is shopping at or is intending to shop at can be determined). Locations of the items, if available, may be provided by the server 50 to the mobile device possibly along with an indication of a suggested order to acquire the items. If the user goes to a different store 60 than expected, the items may be reordered to be more efficient for the store 60 at which the user is visiting. At some time after an item 70 has been found by a user, the user may indicate the item has been found to the mobile application. In determining possible locations for the item 70 that was found, the locating system may assume that the possible locations are confined to locations where a user could have acquired the item 70 (e.g., was temporarily stationary and/or making movements consistent with picking up an item 70) and that occurred after the user had indicated an item previous to the item 70 was found but before the user has indicated that an item following the item 70 was found (and possibly after the user had received directions to the item 70 and before the user had received directions to an item following item 70). For example, if a user indicates that eggs 410, pineapple 430 and XYZ brand chocolate cookies 450 were consecutively found at times T1, T2 and T3, respectively, where T2 occurs after T1 and T3 occurs after T2, then the locating system may assume that the location of pineapple 430 occurs at locations of the user where the user was temporarily stationary (and/or making movements consistent with picking up an item) that occur between times T1 and T3 with the most probable location occurring at or near to T2. Combining locations in this manner may avoid the locating system having to consider all possible locations of a user while in a store 60 in determining the locations of different items 70 that the user has indicated were found.

A user may indicate that items 70 were found out of order. For instance, in the case of the list of items 70 shown in FIG. 5, the user may have indicated to the locating system that 2% milk 420 was acquired or found at a time T1 prior to a time T2 at which the user indicated that eggs 410 were acquired or found. The locating system may then adjust the order in which items are being found—e.g. in the case of FIG. 5, may place 2% milk 420 at the start of the list instead of eggs 410.

In order to name items correctly and consistently, a locating system could be created with a pre-configured list of item names from which a user would be required to select. For instance, when adding XYZ brand chocolate cookies 450 to the list of FIG. 5, the user may have entered “cookies”, then selected the specific item that the user desired to locate from a list provided by the locating system that the locating system has been preconfigured to associate with the generic term “cookies”. Alternatively, as the user started to type “XYZ brand chocolate cookies” a complete item name may be suggested by the locating system to the user. The locating system providing specific item names may help resolve ambiguities in a generic term provided by the user such as “cookies”. For example, in the case of an item named generically by the user as “DVD”, the user may be required by the locating system to select from among “DVD film”, “blank DVD”, “DVD player”, or “DVD recorder”. The locating system could allow for synonyms and for new names (either for new or existing items) created by users. The locating system may have specific entries providing known locations for different brand names or may group similar items of different brand names (e.g., different brands of mayonnaise) together in terms of maintaining location data on the assumption that a store would keep multiple brands of a same type of item roughly in a common location. The locating system may be able to be configured to handle nicknames and synonyms, such as “mayo” for mayonnaise. The locating system could also allow for items named using different languages.

User interaction with a locating system (e.g. as supported by an application on the user's mobile device) may be via keyboard and screen, touch screen, voice, images, video, gestures, and/or movement via a mobile device possessed by the user. For example, referring to FIG. 5, a user could indicate that a selected next item was found via a single flick of a mobile phone or that the item was not found and is to be skipped by a double flick. The mobile device could then provide spoken directions or a visual map to the item following this. Alternatively, a user could move the phone close to an item that was found, shooting video at the same time or taking one or more photographs, to imply to the system via the enlarged image that the shown item had been found. An item display (e.g., shelf) could also be imaged. A user may also move a mobile device to be next to any found item before entering “item found” in order to more accurately provide (and later find) its location. When the locating system may be able to recognize certain items from a photograph or video, a user may input the locations of items that have been found by taking photographs or video of the item, with the mobile device or locating system recognizing the item. Conversely, if the locating system cannot recognize a certain item, a user may photograph or take video of the item and inform the locating system of the item identity. The locating system can then store both the item location and compile a library containing images of the item and/or data obtained by analyzing these images. Data obtained from many users (or at separate times from the same user) may be used to enable the locating system to eventually recognize the item.

In some embodiments, the location history for a user along with item found information provided by the user (when looking for items in a certain area such as a store) may be transmitted as a single package to a server 50 by the mobile device 10 for the user. In such embodiments, indications may be included in the package that indicate where and possibly when along the location history for the user the user indicated that any item had been found or acquired. Indications may further be included in the package that indicate a probability or weight that a particular location in the user location history corresponds to the location of an item that was indicated as found by the user. In other embodiments, indications with the relevant portion of the location history of the user may be transmitted to a server 50 one at a time or in small groups as each item (or as a small number of items) is indicated as being found or acquired by the user. In some embodiments, the server 50 may already have sufficient crowd sourcing data that the server 50 does not need further location history information associated with an item that has been found or acquired by the user. In such embodiments, a mobile application may be provided with a location of an item that a user needs to find by the server 50 and also instructed to not provide location history information associated with the user indicating that the item has been found. Such embodiments may decrease an amount of unnecessary data transfer and data collection.

Besides allowing users to find items or places one at a time where the next item or place to be found is only decided after a previous item or place has been found (or skipped, indicated as not found or canceled), a locating system could enable users to find a sequence of pre-agreed or pre-configured items or places, arranged in the form of a list, where the next item to be found after any previous item has been found or skipped is already known. Such a pre-agreed or pre-configured list of items or places could be useful at a museum, art gallery, amusement park or other location where a user prefers to be guided around rather than making individual decisions. The locating system can still determine the locations of items or places on the list by means of a user entering an “item found” or “place found” indication and/or by other interaction occurring with the user applicable to being at or near an item or place on the list. For example, at an art gallery or museum or historic site, a user could request (or a locating system could provide when the user indicates an item or place was found) information (e.g. verbal and/or visual) about the item or place. The provision of this information and a determination that a user was stationary or only moving by a small amount after it was provided would be a good indication that the user was next to or near the item or place, thereby enabling the locating system to obtain fresh information on the location of the item or place (e.g. and update its database).

### Example of a Locating System

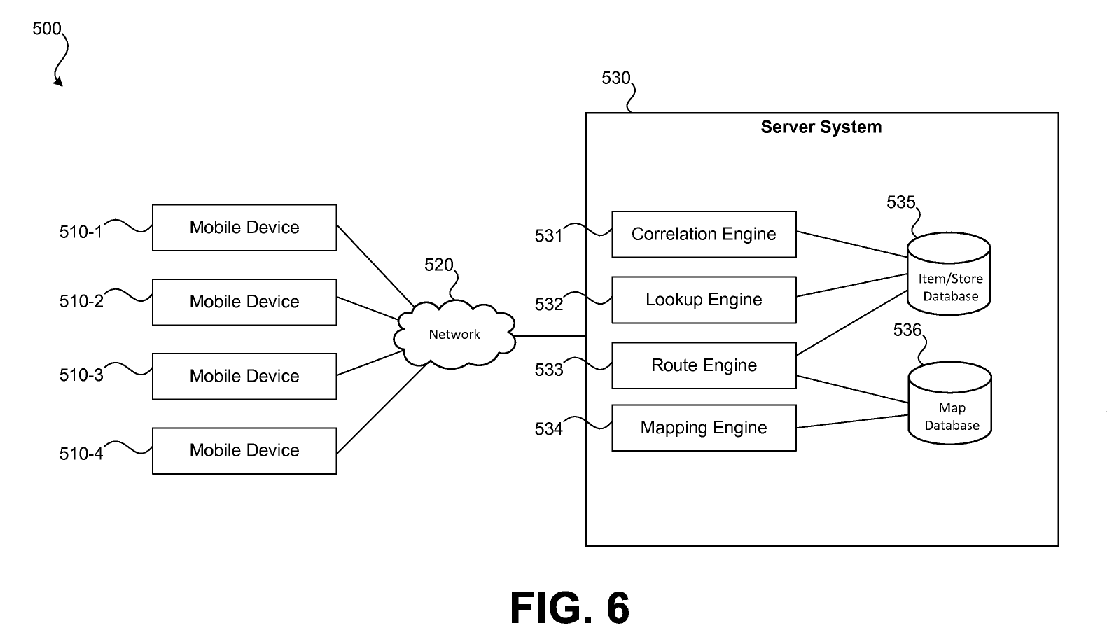

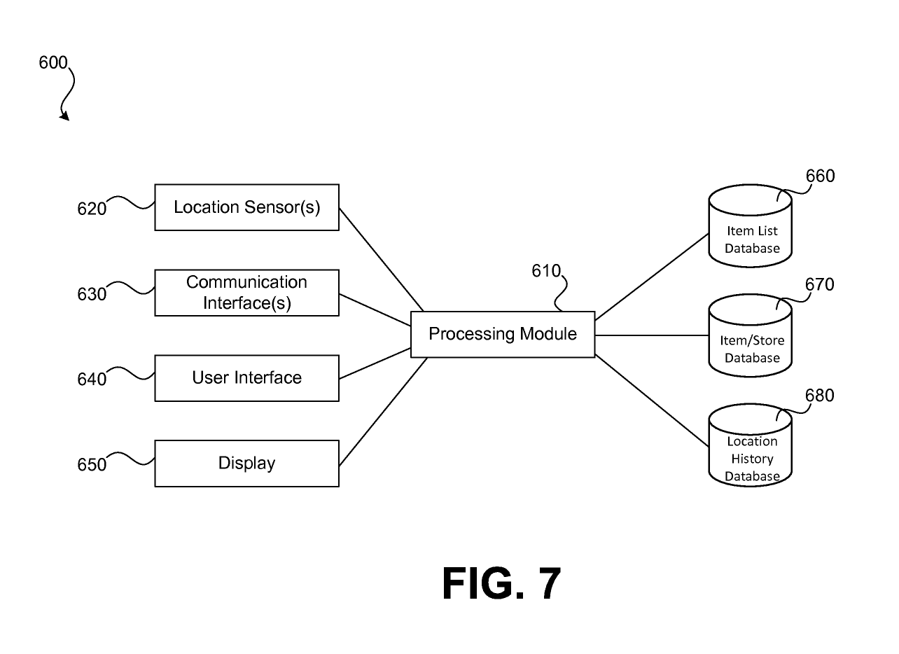

FIG. 6 illustrates an embodiment of a system 500 for determining the locations of items. System 500 in FIG. 6 may correspond to a locating system and may correspond to some of the elements depicted in scenario 90 in FIG. 1. In particular, mobile devices 10 in FIG. 1 may correspond to mobile devices 510 in FIG. 6, server 50 in FIG. 1 may correspond to server system 530 in FIG. 6 and network 30 in FIG. 1 may correspond to network 520 in FIG. 6. System 500 may represent a locating system that can perform both location assistance and location self learning—e.g. that can both crowd source the location of items as indicated by users to the locating system and provide users with indications of the locations of items within particular stores (or within other areas and places), a map of the store (or other area or place), and/or an efficient order in which to acquire items within the store (or other area or place). Mobile devices 510 may represent the mobile devices via which users specify the desired items, location history information is collected, item found or acquired information is collected, and location information is provided to users. Each of mobile devices 510 may be operated by a different user. Each of mobile devices 510 may be capable of determining its location, such as via GPS or some other form of satellite-based or other positioning system (e.g. such as sensors on the mobile device or detection and measurement of signals transmitted by nearby WiFi APs, BT APs or cellular base stations). Further detail regarding a mobile device is provided later herein in relation to FIG. 7. Network 520 may represent one or more networks, including one or more wireless networks and the Internet, used by mobile devices 510 to communicate with server system 530.

Server system 530 may include a correlation engine 531, lookup engine 532, route engine 533, a mapping engine 534, an item/store database 535, and/or a map database 536. It should be understood that such components are merely exemplary. Such components may be combined or divided into a greater number of components. Correlation engine 531 may serve to analyze received location histories and indications of found or acquired items from mobile devices 510. By comparing and contrasting location histories from two or more mobile devices, correlation engine 531 may determine locations of items within a particular store. For instance, if correlation engine 531 has access to tens, hundreds or thousands of location histories obtained from different mobile devices 510 which are each associated with a common item in a common area such as a common store, a location of the item that each or most of the location histories have in common or nearly in common may be determined. This most common location may be indicative of the location of the item in common among the location histories. Further accuracy may be gained by analyzing where, along each location history, users provided an indication that the common item was found. For instance, users may normally provide indications that any item has been found only within a short span (e.g. 10 to 30 seconds) of finding and acquiring the item, where the indication may be provided in advance of finding the item (e.g. when a user sees an item while still approaching the item) or after the item has been found (e.g. when a user may be ready to look for the next item and needs to indicate to the locating system that the item has been found in order to receive directions to the next item). Therefore, correlation engine 531 may only analyze the portion of the location history for each user that is directly associated with finding the common item by virtue of being created starting a short time (e.g. 10 to 30 seconds) before the item was indicated by the user as found and ending a short time (e.g. 10 to 30 seconds) after the item was indicated as being found. In some embodiments, only a portion of the location history gathered during a predefined period of time either before or after the indication that the item has been found (but not both before and after the item was found) may be considered to accommodate embodiments of a locating system in which a user is required or can otherwise be trusted or assumed to provide “item found” indications consistently before or after an item was found. In some embodiments, correlation engine 531 may only consider locations on a location history gathered for a user by a mobile device where the mobile device (e.g. sensors on the mobile device) determined that the user was stationary or almost stationary and/or was making movements consistent with acquiring (e.g. picking up) an item. Correlation engine 531 may then look for a common location on that portion of the location histories for most or all users that is directly associated with finding the common item as described above and/or that is restricted to the locations where the user may have been acquiring the common item (e.g. while being stationary). Once an item has been located within a particular store by correlation engine 531, an indication of the location may be stored to item/store database 535. Since, of course, different stores keep the same item in different locations, a same type of item may have different entries in item/store database 535 depending on the store. Moreover, when a range of locations is determined by correlation engine 531 for some common item (e.g. such as may occur when a type of item is spread along a shelf or rack in a store or on several racks or shelves), the range of locations may be stored rather than just a single location.

Lookup engine 532 may serve to access item/store database 535 to determine the location of an item (if stored within item/store database 535) for providing a location indication to the mobile device of the user. Lookup engine 532 may respond to a request received from a mobile device that is requesting the location of an item. The request may indicate a particular location, area or place, such as a store.

Route engine 533 may receive the indications of multiple items that the user desires to acquire in a particular store. Based upon a map of the store and/or the locations of the types of items as indicated within item/store database 535, route engine 533 may provide the user via his mobile device with a suggested route or order in which items should be acquired by the user. Such a route may be provided in the form of a map with directions overlaid on the map or in the form of turn-by-turn directions to bring the user from one desired item to the next.

Mapping engine 534 may serve to create, enhance, and/or update maps based on analyzing location histories of multiple mobile devices to determine locations within a store likely occupied by an object, such as product shelves or otherwise inaccessible to normal users (e.g. areas reserved for store employees) where user locations will seldom or never occur and locations where user movement is permissible (e.g., aisles) where locations of many users will typically occur. In tracking users' movements within a store via the location histories, mapping engine 534 could create an internal map of a store showing aisles and areas inaccessible to users such as product racks along the sides of aisles. Creating an internal map of a store may subsequently assist a locating system with providing directions to users to find different items in the store. Mapping engine 534 may take into account locations that occur on many user location histories versus locations that occur on few or no user location histories and/or locations at which a user has indicated that an item was acquired. For instance, locations determined by correlation engine 531 to correspond to locations of items in a store will generally coincide with or be adjacent to inaccessible areas such as product shelves and walls. Mapping engine 534 may create, store and/or update maps of individual stores to map database 536. An appropriate map may be provided to the user via a mobile device 510 based upon a store selected by the user or based on the user's location or known habits. Additionally or alternatively, rather than create a map of the store, the mapping engine 534 can enhance an existing map by providing additional information for the map, such as semantic information or annotation, to associate an item or type of item to a location on the map and/or provide a point of interest on the map.

In some embodiments, some or all components of server system 530 may be supported on one or more of mobile devices 510. In such cases, a mobile device 510 that supports some or all components of server system 530 may not need to interact with a separate server system 530 but may instead determine and store locations of items in its own database and obtain locations of items from this database. In some cases, mobile devices 510 may crowd source location histories and indications of items being found to one another and not to a separate server system 530. In these cases, mobile devices may support peer to peer interactions. In some hybrid cases, components of server system 530 may be supported on some mobile devices 510 with a separate server system 530 also supported as shown in FIG. 6 and as described earlier. In these hybrid cases, local support of components of server system 530 on a mobile device 510 may provide greater efficiency—e.g. with databases 535 and 536 being supported by a mobile device 510 only to store item locations and/or maps for stores frequently visited by the user of mobile device 510 and/or associated with items frequently found by the user of mobile device 510. In this hybrid case, a mobile device 510 that contains some or all components of server system 530 may still interact with a server system 530 to crowd source location history and item found information and request location and map information not stored locally in mobile device 510.

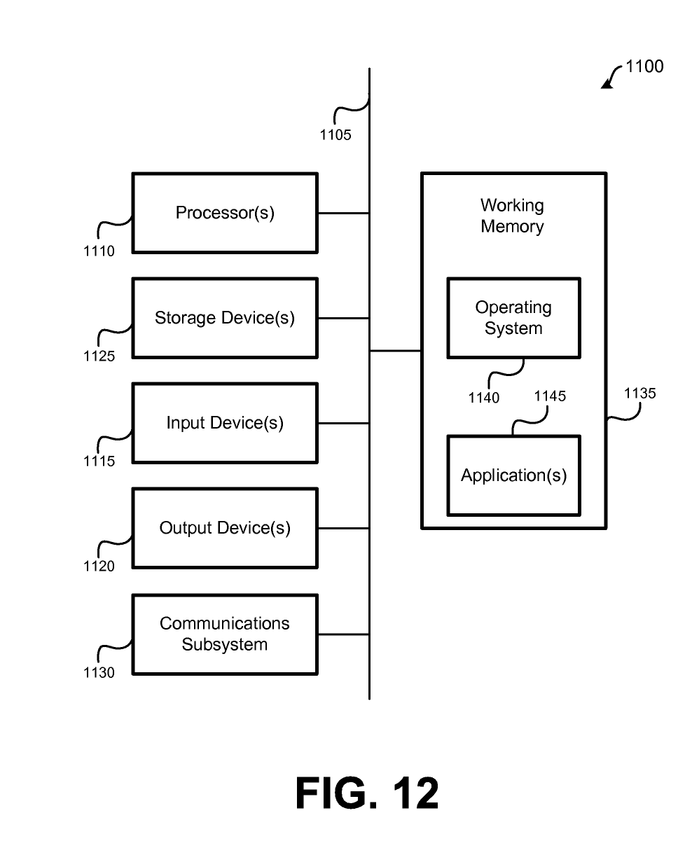

FIG. 7 illustrates an embodiment of a mobile device 600 for acquiring a location history, indicating located items, and/or receiving indications of locations of items. Mobile device 600 may correspond to one or more of mobile devices 510 in FIG. 6 and/or to one or more of mobile devices 10 in FIG. 1. Mobile device 600 may include processing module 610, one or more location sensors 620, one or more communication interfaces 630, user interface 640, display 650, item list database 660, item/store database 670 and location history database 680. Mobile device 600 may include various computerized components, such as those presented as computer system 1100 of FIG. 12. Mobile device 600 may thus be computerized and can include one or more instances of the components detailed in relation to computer system 1100.

Processing module 610 may include one or more processors that are configured to process information received from location sensors 620, communication interfaces 630, and user interface 640. Processing module 610 may also output information to display 650 and communication interfaces 630. Processing module 610 may access item list database 660, item/store database 670, and location history database 680.

Location sensors 620 may be used to determine where a mobile device, and the user possessing the mobile device, are located. Accurate positioning of a user via location determination by the user's mobile device could make use of one or more types of inertial sensors (e.g., accelerometer, gyroscope, magnetometer, compass, barometer). One or more of such types of inertial sensor may be included in location sensors 620. Measurement by mobile device 600 of signals from wireless network access points (e.g., WiFi access points), Bluetooth access points, Femtocells, and/or detection by the mobile device of fixed Radio Frequency Identification (RFID) devices (e.g., using Near Field Communication (NFC)) that are at known locations may also be used to determine the location of mobile device 600. Detection of such wireless signals may be accomplished via communication interfaces 630. In some embodiments, a mobile device 600 could be accurately positioned prior to entry to a store and possibly while within a store using a global navigation satellite system (GNSS) such as GPS, Galileo or GLONASS with the location of the mobile device tracked subsequent to entry to the store using inertial sensors of the mobile device. In these embodiments, measurements of GNSS satellites may be made by means of Communication Interfaces 630 and Processing module 610 and location determination using these measurements may be performed by Processing module 610.

Communication interfaces 630 may permit communication with a remote server system, such as via local wireless networks and/or cellular networks. Communication interfaces 630 may allow for the reception and transmission of data with a remote server system such as crowdsourcing the location of items to a remote server system and querying for the location of items from a remote server system. Communication interfaces 630 may also permit for location determination via detection of access points, RFID devices, and/or femtocells as detailed above.

When using the mobile device 600 where items need to be located accurately (e.g., to a fine level of precision) such as at home or in an office, the mobile device 600 could allow a user to periodically reset or recalibrate the location of the user's mobile device using a particular known reference location in order to remove accumulated errors in any estimate of the mobile device's current location. For example, if a locating system is being used at a location where GNSS signal reception is poor and where there are few or no wireless network access points, few or no Bluetooth access points, and few or no Femtos that may be measured by a mobile device to determine its location accurately, positioning of the mobile device may be mainly or exclusively reliant on use of inertial sensors in the mobile device (e.g., such as an accelerometer, gyroscope, magnetometer, compass and/or barometer) which may typically be accurate only over short periods (e.g., up to 10 minutes) following an absolute positioning determination of the mobile device. Due to an accumulation of errors over time, positioning may gradually become less accurate when inertial sensors are relied upon.

A precise reference position may be established if the user places the user's mobile device at a certain known location (e.g., in the middle of a particular doorway or at a certain corner of a desk or cupboard) and informs the mobile device of the current location. Alternatively, a precise reference location may be established using a single wireless network access point, Bluetooth access point or NFC device by placing the mobile device nearby to this AP or device and indicating this has occurred to the locating system (or in some cases letting the locating system determine this via detection of particular access point or NFC signals). The absolute location (e.g. latitude, longitude and altitude) of a reference location may be determined by the locating system from mobile devices that still have an accurate location for themselves (e.g. obtained recently using GPS and kept updated accurately for a short time using inertial sensors) at the time of being placed at or next to the reference location. In some embodiments, rather than the locating system determining an absolute location of a reference location, the locating system may be able to obtain accurate locations for items relative to this reference location which may suffice to find items at a later time. For example, a user may reset (or recalibrate) the location of the user's mobile device by placing the mobile device at the reference location and indicating to the locating system (e.g., to an application on the mobile device) that the mobile device is at the reference location. The system may then reset the location of the mobile device relative to the reference location to zero (meaning the mobile device is at the reference location). Although the locating system will not then necessarily know the absolute location of the mobile device, the locating system will know that the mobile device is at or next to the reference location. The locating system can then provide directions to items whose locations relative to the reference location are known. In addition, the locating system can create a location history for a user after the user moves away from a reference location where the location history specifies the user's location relative to the reference location.

As an example, after visiting a reference location, the user may move the user's mobile device to be at or near to the location of some item of interest and may inform a locating system that the item has been found. The locating system may then store the location of the item relative to the reference location which may be determined from inertial sensors in the mobile device that indicate how far the mobile device has moved from the reference location—e.g., may indicate that the mobile device has moved 15 feet west, 25 feet north and 3 feet upwards away from the reference location. At a later time, the same user or another user may wish to find the same item or same type of item and may place the user's mobile device at the previous reference location and indicate to the system that the mobile device is at the reference location. The system may then reset the location of the mobile device relative to the reference location to zero. The user may then query the system for directions to the item or type of item and, knowing that the mobile device is currently at the reference location, the system may direct the user to move 15 feet west, 25 feet north and 3 feet upward (e.g., with the user then looking for the item on a high shelf). If the user had queried for the location of the item or type of item sometime after having moved away from the reference location with the current location of the mobile device relative to the reference location then being, for example, 10 feet east, 10 feet south and at the same altitude, the system can give directions to the user to move 25 feet west, 35 feet north and 3 feet upward.

Periodic recalibration of a mobile device's current location can also make use of any known locations of products and items in a shop or other known locations such as those for an entry door, elevator, check out register, start of a shopping aisle etc. When a mobile device determines that the probable error in its current location estimate exceeds some threshold, it can signal the user—for example, when the user requests directions to another product or item. The user could then be given the option of standing next to some known reference location (such as the known location for a certain product) and indicating when the mobile device is properly positioned. The locating system could give the user several different known reference locations nearby to the user's expected current location allowing the user to select one of them, move to the reference location and indicate to the locating system when there.

With periodic recalibration, a locating system could function adequately for some initial period using any location already known to a mobile device that may have been obtained (e.g., using GNSS positioning or assisted GNSS (A-GNSS) positioning outdoors in conditions that enable accurate GNSS or A-GNSS location) just before a user enters a store. Subsequent to entering the store, the mobile device may no longer be able to update its location using the same method as before entering the store (e.g., using A-GNSS), but may be able to employ inertial sensors in the mobile device to maintain an accurate current location estimate for a threshold distance or period of time, such as a further 5 to 10 minutes. This may be sufficient for a locating system to determine the locations of some items that are found by the user and thereby establish a number of reference locations (given by the known accurate locations of any items located in the first 5 to 10 minutes a user is inside a store). Other users may similarly enable other reference locations to be obtained by the locating system. The locating system may then combine different location estimates from many users for the same item or type of item to further improve the accuracy of an associated reference location (e.g., through averaging). Users who have been in a store for longer than 5 to 10 minutes can then make use of these known reference locations to periodically reset the current locations of their mobile devices (by moving next to some already known reference location and indicating this to the locating system) and thereby restore location accuracy. With this method, having wireless network access points, Bluetooth access points and/or Femto cells inside or nearby to a store to enable wireless network, Bluetooth or Femto-based positioning may not be needed. Instead, mobile devices may use known reference locations to periodically reset (or recalibrate) their current location estimates followed by sensor-based location (and possibly location based on image recognition) for short periods following any location recalibration at a reference location. Of course, if sufficient GNSS signals are available to enable accurate absolute positioning, an absolute position may be used for positioning without using any additional location determination method.

Returning to FIG. 7, user interface 640 may permit a user to provide input to mobile device 600. For instance, referring to FIG. 5, a touch screen may be present on mobile device 600 that allows the user to input indications of items to be found and for indications of when items are found or acquired to be indicated. Display 650, which may be part of a touch screen, may be used to present information to a user, such as the location of an item within a store.

Item list database 660 may indicate a storage arrangement on a non-transitory computer-readable medium where indications of items that a user desires to locate are stored. While at a store or prior to going to a store, the user may input a shopping list. This list may be store-specific (e.g., the user may indicate the store at which the shopping list will be used) or the best store for the items entered may be determined Such a best store may be a store within a predefined distance that has in stock the greatest number of the items indicated. Historical item lists may be saved. For instance, when building a shopping list, a user may desire to start with a saved list that the user previously used.

Item/store database 670 may store known or probable locations for items within a particular store. Therefore, a particular item may have multiple entries in item/store database 670 for different stores. Item/store database 670 may only be used by mobile device 600 in a standalone mode as described later herein. In some embodiments, item/store database 670 may be used to store locations of items in a store that have been previously retrieved from a server system handling crowdsourcing. In that case, the location of the item may not need to be retrieved from the remote server in response to future requests for the same item. In some embodiments, item/store database 670 may be the same as or a subset of item/store database 535 in FIG. 6 and may support a hybrid mode as described in association with FIG. 6.

Location history database 680 may store the user's location history for individual visits to a store. The location history may be transmitted to a remote server (e.g. server system 530 in FIG. 6 or server 50 in FIG. 1) via communication interfaces 630 along with indications of when particular items were found. If operating in a network mode as described later, as the location history is transmitted to the remote server, the location history may be cleared from location history database 680. In standalone mode, as described later, location history data may be maintained such that the locations of items within a store can be determined by the mobile device without using crowd sourced data from a remote server.

### Weighting of Locations in a Location History

In some embodiments, the locations of a mobile device (and thus generally the user of the mobile device) in a location history may each be assigned a probability or weighting factor that is associated with the probability of the user being nearby or next to an item being found. The probability or weighting factor may be higher if mobile device sensor measurements are consistent with the user being nearby or next to the item being found (e.g. if sensor measurements indicate the user was stationary, or substantially stationary, for more than a threshold period of time or if sensor measurements detect that the user was potentially stooping or lifting something, or otherwise making movements consistent with acquiring, examining or verifying an item). The probability or weighting factor may also be higher for user locations that occur at a time close to (e.g., within a threshold period of time to) or the same as the time the user indicated the item was found—e.g. the probability or weighting factor may be inversely proportional to the difference in time between the occurrence of any user location and the time when the user indicated the item was found, with some finite high value being used when the difference in time is zero. In general, the shorter the amount of time that has elapsed between the user providing an indication of the item being located and when the mobile device was present at a location of the location history, the more likely the location may be considered to correspond to where the store keeps the item. Thus, a greater weight may be assigned to a location associated with a shorter elapsed time. Such a weighting may be useful because, as a whole, a user may be most likely to indicate that an item has been found shortly before or shortly after finding or acquiring the item.

If a probability or weighting factor is used, a location for a type of item may be obtained (e.g. by a server 50 or server system 530) by averaging candidate locations for the type of item obtained from the location histories for many users. The candidate locations may comprise locations for each location history where mobile device sensors detected that a user was stationary, almost stationary and/or possibly acquiring, examining or verifying (e.g. picking up) an item. Alternatively or in addition, candidate locations could be locations that occur periodically (e.g. every 5 seconds) along a location history—e.g. if a mobile device is not able to detect whether a user is stationary or possibly acquiring an item. For each candidate location, a probability or weighting factor may be assigned as just described. A location for a type of item may then be obtained as a weighted average of the candidate locations for the type of item wherein the weights are equal to the assigned weighting factors or probabilities for the different candidate locations. Alternatively, the location of the type of item may be inferred by finding some small area (e.g., a circle of radius 5 meters) for which the sum of the weights or the sum of the probabilities assigned to those candidate locations that are within the small area is greatest, where the sum is for all candidate locations from all user location histories that are within the small area. The location of the type of item may then be obtained as the weighted average of the candidate locations contained within this small area, where the weighted average uses the weights or probabilities assigned to the candidate locations. In performing this determination, as before, the location history of each user may be restricted to locations that occur near to when (e.g., within 10 to 30 seconds to when) the user indicated the type of item was found in order to eliminate other common locations that the users may share such as locations around the entry to the store.

Some situations may require special handling. For instance, the same type of item may be located in more than one place in a store (e.g., candy at a supermarket). A type of item may also be located over a significant area (e.g., office furniture at an office store or garden furniture at a home improvement store). Further, the location of a type of item may periodically be changed. In order to handle such situations, a locating system can monitor for non-convergence on the most probable location of a type of item (e.g., as determined from location input from multiple users who have found the type of item over a period of time) and assign a range of locations for a situation where several probable locations emerge from crowd sourcing. A locating system can also monitor for the appearance of new locations of a type of an item and the disappearance of previous locations. In some embodiments, a locating system may be alerted to the disappearance of an item from a location by a user providing an “item not found” indication. For instance, referring back to FIG. 5, a user may be provided with an additional input button that can be selected if a particular item was not successfully located at a location indicated by the system.

### Standalone and Network Modes

In order to initially seed information on the location of different types of items in a store, when a locating system has no information on such locations, the locating system may operate in a “standalone mode”. In the standalone mode, a user's mobile device may collect and store the locations of items found by the user (or store the locations on a server but only accessible to the mobile device that provides them). The locating system, therefore, would collect and store indications of locations found initially by the user but would not initially assist the user to find the items. However, once the location of a type of item was obtained by the locating system, the locating system would be able to provide directions to the user the next time the user needs to find the same time of item—e.g. if the user no longer exactly remembers the location. Such a standalone mode may be useful for a user who shops at several stores and may not always remember where every item is located within each store.

While the standalone mode may permit data to be gathered and information to be provided to a user based on information that a specific user has previously provided, it may be more useful for locations of items to be crowd sourced over time. A locating system may therefore offer users a “network mode” option in which data gathered by a user (e.g., by an application on the user's mobile device) would be uploaded to a server of the locating system and used to determine the location of items by being combined with location history and item found information crowd sourced from mobile devices for other users. In exchange for sharing the user's data, the user (e.g., an application on the user's mobile device) may be permitted by the locating system to access the locations of items determined by the locating system using such crowdsourcing. As an inducement for a user to use the network mode and allow the user's location history data and indication of when items were found by the user to be provided to a server of the locating system (or to applications on other mobile devices in the locating system using peer-to-peer signaling), the amount of data made available to a user (e.g., to an application on the user's mobile device) could depend on the amount of data the user is providing—e.g., with more data being provided to a user in exchange for more data being provided by the user. In some embodiments, the user may pay for access to crowd sourced information. Such information may also be provided for free (e.g., via an advertisement-supported model in which the user receives advertisements in exchange for data on the locations of items in a store).

In some embodiments, a user may receive directions to preferred items when entering the name of more generic items—e.g. a user who asks a locating system for directions to “fruit juice” may receive directions to particular brands of fruit juice that may be preferred by the operator of the locating system or by the user (e.g. based on previous known user searches) and may in addition be provided by a locating system with these preferred brand names. In some embodiments, the locating system may first recommend or suggest preferred brands to a user after which a user may accept or reject the recommendations or suggestions. If a user accepts a particular recommendation or suggestion, the locating system may then provide directions to the recommended or suggested brand name. In some embodiments, a locating system may provide additional information about available or preferred brand names (e.g. particular brands of fruit juice in the previous example) such as the current price, whether any discount is available and feedback from other users on brand names. This additional information may assist users in deciding whether particular items are still wanted and need to be found and/or whether other (e.g. related items) are now wanted and need to be found.

Additional information may also be provided by users to a locating system (e.g. to an application on the user's mobile device) at the time of indicating that a particular item was found or was to be skipped or at a later time (e.g. after purchasing and sampling a particular item) and/or may be provided by store owners and/or brand name owners and suppliers. The additional information may include information on pricing; item availability (e.g. stores where an item is available or is not available); item quality, suitability and/or reliability. This additional information may then be provided by the locating system to users who may wish to find the item, find information about the item or find or find information about related items or a category of items that includes the item. The operator of a locating system may receive revenue from store owners and/or brand based suppliers and owners who provide additional information on items (e.g. in the form of advertising) in exchange for accepting the additional information and providing it to users. The operator of a locating system may then be able to provide location assistance to users without any charge and/or without any obligation to necessarily crowd source data on items that were found.

Data provided by a user (e.g., by an application on the user's mobile device) concerning the locations of different types of items that were indicated as found by the user may be validated by a locating system (e.g., by a network server for the locating system) by comparison with data received from one or more other users. This may be done in order to detect users who may be cheating (in order to gain access to more data from the system) or deliberately providing false data or whose mobile devices may be providing inaccurate location history data due to a poor location capability or an erroneous implementation of the locating system. The data collection process may also help validate data—e.g., by insisting on the serial collection of data as users move around and find new items in a store. A “fast mode” of gathering data may also be supported (e.g., when a user is first entering found items into a database in standalone mode) in which a user enters found items individually or in batches at their respective locations.

In populating a database (both locally in a mobile device and via crowd sourcing at a server system), a level of uncertainty and confidence may be included representing the level of correlation from multiple findings of the same type of item (either by the same user at different times or by different users) and the expected accuracy of the location (e.g., based on a sensor-based location determination). Directions to users may then indicate such uncertainty and confidence by informing a user when a location of an item to be found is probable but not certain, and/or by providing a region or area within a store where a type of item is located rather than a specific point location. As additional location data is crowdsourced, the location of the type of item may be refined—e.g., by averaging the probable locations of a common type of item determined from different user location histories.

In some embodiments, rather than data from one or more users being used to initially seed item location information, one or more trusted users may be allowed or assigned to provide locations of items. For instance, an agent of the entity operating a locating system and/or an agent of a store for which item locations need to be obtained may provide a locating system with locations of items. For such locations, the trusted user may be required to provide an indication that a type of item has been found immediately in the vicinity of the item (e.g., when the user is standing next to the item), such that the location of the type of item does not need to be refined via crowdsourcing.

In order to avoid sending inaccurate or erroneous data to users, the location of a new item (whose location is not yet known by a locating system) that is provided by any one user could be made available only to that particular user (as in standalone mode) for some quarantine period of time during which the location may be augmented with additional location information from other users for that type of item. Therefore, independent confirmation of a location of an item from multiple users may occur before the item location is shared by the locating system with other users. Once sufficient location data for a new item has been gathered from multiple users to enable an accurate and reliable location (or set of locations) to be determined, the location data may be released by the locating system to the general community of users. As an alternative, the locations of items in quarantine may be provided to other users with a warning that the location is not considered fully reliable. If the location of an item is provided via photograph or video that enables independent identification and verification by the locating system of the item, the location of the item may be trusted and not require crowdsourcing before it is shared with other users (e.g., since indication by the user that the item was found plus an independent confirmation of the item from a photograph or video would make misidentification and inaccurate location less likely).

A locating system may also offer a combination of standalone plus network mode in which standalone mode is used in some situations and network mode in others. For example, a user may be enabled to define certain general locations (e.g., home or office) where location data of items will only be gathered and provided in standalone mode and not made available to other users for privacy reasons. For other general locations (e.g., shopping malls and stores), the user may use network mode. In addition, users may use network mode within limited closed groups (e.g., consisting of family members or employees at a particular company) where data on the location of items is shared only among the particular set of users making up the closed group, such as for privacy reasons.

A locating system may also be used to find items at a very fine level of resolution—e.g., by moving a phone next to some item before entering an “item found” indication. This may be useful to locate items inside cupboards, cabinets, store rooms etc. As an example, when used in standalone mode, a locating system may enable a user to store (and later find) the locations of dozens or even hundreds of personal items inside a house—which typically may get forgotten until a user performs general tidying and clearing (e.g., every few years). The locating system may assume a certain level of required location accuracy or this may be defined by a user. Whether information related to locations of items is kept private for the user or is made public may be based on the general location of the user. For instance, if the user is determined to be located at a private residence, the location of items may not be used for crowdsourcing and may be kept private. If the user is determined to be in a public location, such as a store or mall, item location information may be used for crowdsourcing.

### Categories of Items

In some embodiments, a user may find general instructions more useful than specific item instructions. For instance, rather than a user inputting various types of fruit that the user desires to acquire in a store, the user may simply request the location of “fruit.” Such a situation may also be common if a user is looking for many types of fruit and does not wish to enter each one individually or is going to choose fruit based on what is appropriately ripe, available, and/or on sale. The user may use the general location of fruit, which is usually all kept in a similar location within a store, to find all the fruit the user wants. Further, a locating system (e.g. a server system supporting a locating system) may provide the location of general categories of items to a user when the location of specific items requested by the user are unknown. For instance, if a user requests the location of “bananas” and a locating system does not have a specific location for bananas stored but does have a location for fruit in general or one or more locations for specific types of fruit other than bananas, the user could be directed to the location or locations for fruits in general or to the location or locations for other types of fruit, possibly with an advisory that the location or locations may not be completely accurate and reliable.

More generally, a locating system may support directions to users related to categories of items and make use of the general tendency of stores to locate items belonging to the same category in approximately the same location. For example, apples, oranges and tangerines are particular examples of fruit; potatoes, leeks and green peppers are particular examples of vegetables; and fruits and vegetables are particular examples of fresh produce. Although a locating system can query for specific items from a user when the user enters say “fruit” when in a supermarket, the system could provide directions to the fruit section as a whole or to the fresh produce section if the location of fruit is unknown but the location of fresh produce is known. A locating system may be configured in advance with information on categories of items (e.g. information concerning particular items that belong to a particular category) and may use this information to extend and/or initially seed the database that is created by the locating system for a particular store. For example, if a locating system learns that at a certain supermarket, apples are found at location A, oranges at location B and pears at location C, the locating system may infer that fruit (and possibly fresh produce) can be found in the general vicinity of locations A, B and C—assuming these are fairly close to one another. Further, if a locating system learns that fruit or particular examples of fruit (such as apples or pears) can be found at a supermarket in the vicinity of location X, it can assume that oranges may also be found nearby to location X even if the locating system had no previous information concerning the location of oranges.

Categorization of items may also be partly inferred from user input—e.g. if a user enters “copper pipes” in a home improvement store and a locating system either does not recognize the name “copper pipes” or does not know their location in the particular store, the locating system may prompt the user to enter a different but related name. If the user then enters “plumbing”, the locating system can then link the two names (i.e. “copper pipes” and “plumbing”) in its database for that store or for multiple stores. Subsequent entry by other users of the name “plumbing” in association with the names of other specific items (e.g. “faucet”, “hot water tank”, “water shut off valve”) may lead the locating system to infer that the name “plumbing” is a category of item and may provide the locating system with the names of particular items belonging to this category.

Categories of item may be extended in some embodiments of a locating system to include items that share only some of their attributes. For example, such categories could include “school materials”, “fifth grade start of school materials”, “auto maintenance items”, “fast foods” etc. A locating system may not initially know which items belong to such categories and may initially rely on users to tell the locating system which items normally belong to these categories. For example, a number of users may visit stores a few weeks before the start of the Fall school semester with lists of items they need for their children who may be about to start fifth grade at school. The users may already know some of the items they need and may query the locating system (e.g. after entering a suitable store) for directions to “fifth grade start of school materials”. Initially the locating system may not know the names for any items belonging to the “fifth grade start of school materials” category so may prompt users to enter names for individual items. This may not help users much initially but after a few days of such querying the locating system may build up a list of the items most commonly queried by users in the context of “fifth grade start of school materials”. At that point, the locating system may present a list of such items to users who query for fifth grade start of school items and allow users to select the items they need from the list. The locating system can also provide directions to these items for the users and provide directions in some optimum order (e.g. to minimize walking) and possibly indicate the popularity of these items with other users.

### Location Self Learning Embodiment

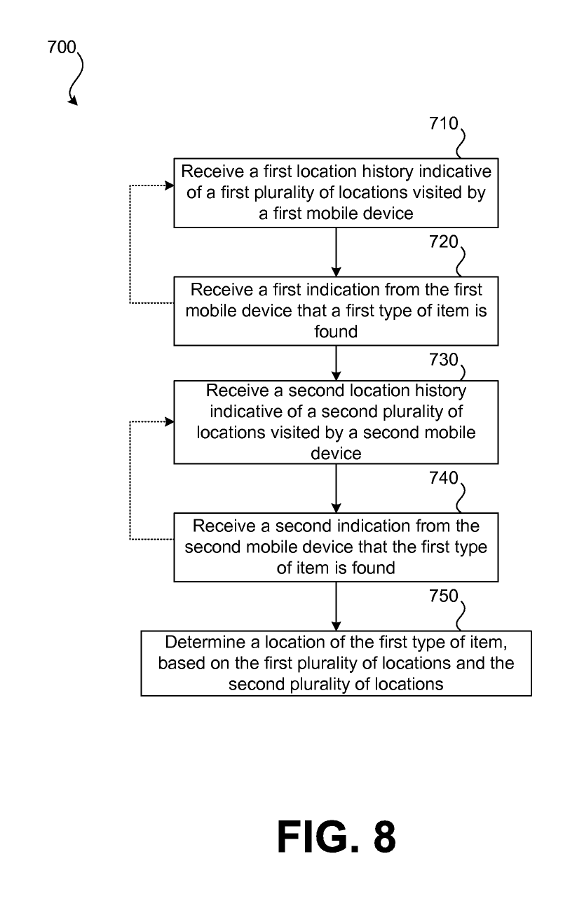

FIG. 8 represents an embodiment of a method 700 for determining a location of an item. Method 700 may be performed by system 500 of FIG. 6 or by some other system (e.g. a locating system) configured to determine the locations of items and, possibly, provide such locations to users. Each block of method 700 may be performed by a remotely accessible computer system, such as server system 530 of FIG. 6 or server 50 of FIG. 1. Such a server system may be in communication with multiple mobile devices of multiple users—for example, with mobile devices 10 of FIG. 1, mobile devices 510 of FIG. 6 or mobile device 600 of FIG. 7. In some embodiments, rather than each block being performed by a remote computer server, a mobile device (e.g. mobile device 10 of FIG. 1, mobile device 510 of FIG. 6 or mobile device 600 of FIG. 7) may operate in a standalone mode, as detailed later herein, and perform each block of method 700. Computer system 1100 of FIG. 12 may be used to perform each block of method 700. Accordingly, means for performing each block of method 700 can include one or more instances of computerized hardware, such as some or all of the components detailed in relation to system 500 of FIG. 6 and computer system 1100 of FIG. 12.

At block 710, a first location history indicative of a first plurality of locations visited by a first mobile device may be received from the first mobile device of a first user. The location history may indicate a route taken through a store. The location history may comprise individual separate locations of the first mobile device or a continuous set of locations of the first mobile device. The location history may further comprise the time, date and time or a range of time for each location in the location history. The location history may additionally or alternatively indicate locations at which the first mobile device (approximately) stopped moving for at least a threshold period of time and/or at which sensors on the mobile device determined that the user of the mobile device was making movement consistent with finding or acquiring an item (e.g. placing an item in a shopping cart). At block 720, a first indication indicating a particular first type of item has been found by the user of the first mobile device may be received. The location history received at block 710 may only be the location history determined prior to the item being indicated by the user as found or may be a location history determined both prior to and after the item being indicated by the user as found. In some embodiments, the location history prior to and subsequent to the item being found may be restricted to a period of time either between the finding of a previous item by the user and finding a subsequent item by the user or between providing directions for the item to the user and providing directions for the next item. Means for performing blocks 710 and 720 may include a mobile device, one or more networks, and/or a computer server system, such as server system 530 of FIG. 6. Means for performing blocks 710 and 720 may include various computerized components, such as one or more instances of components of computer system 1100 of FIG. 12.

At block 730, a second location history indicative of a second plurality of locations visited by a second mobile device may be received from a second mobile device of a second user. However, in some embodiments, the second mobile device may be the first mobile device and the second user may be the first user. The second location history may indicate a second route taken through the same store by the second user. The second location history may additionally or alternatively indicate locations at which the second mobile device (approximately) stopped moving for at least a threshold period of time. The second location history may at least partially overlap the first location history. Additionally or alternatively, a server or other computer system may determine that the first and/or second location history is associated with a particular store. At block 740, a second indication indicating the first type of item has been found by the user of the second mobile device may be received. This may be the same type of item as the type of item located by the first user at block 720. The location history transferred or indicated as relevant to the item at block 730 may only be the location history determined prior to the item being indicated by the second user as found or may be a location history determined both prior to and after the item being indicated by the user as found. In some embodiments, the location history prior to and subsequent to the item being found may be restricted to a period of time either between the finding of a previous item by the user and finding a subsequent item by the user or between providing directions for the item to the user and providing directions for the next item. Additionally or alternatively, the first indication and/or the second indication can include a respective first and second time of finding the first type of item and/or respective locations in the first and/or second plurality of locations corresponding to finding the first type of item. Means for performing blocks 730 and 740 may include a mobile device, one or more networks, and/or a computer server system, such as server system 530 of FIG. 6. Means for performing blocks 730 and 740 may include various computerized components, such as one or more instances of components of computer system 1100 of FIG. 12.

Each one of blocks 710 through 740 may be repeated if the first and/or second users locate multiple items and provide associated indications that the items have been located and/or if additional location histories are received corresponding to block 710 and/or 730. As the user(s) continue to move within the store, the users' mobile devices can continue to create a location history.

At block 750, the location of the first type of item may be determined, based on the first plurality of locations and the second plurality of locations from the first and second location histories. For example, the determination may occur as described earlier herein in association with FIGS. 2-4. In some embodiments, data associated with more than two users is used to determine the location of the item. To determine the location of the item, the two location histories of the users may be compared. The portion of the location histories compared may only be the portion of the location histories gathered prior to the users indicating that the item had been found. In some embodiments portions of the location histories subsequent to finding the item may be compared and, in some embodiments, the compared location histories may be restricted for each user to locations that occurred subsequent to finding a previous item and prior to finding a subsequent item. Locations in common, if any, may then be determined. Such locations may be places where the location histories at least approximately intersect and/or approximate places in common at which the mobile devices approximately stopped for a threshold period of time. It may also be determined if the locations in common may correspond to any item other than the particular item for which the location is being determined in which case such locations may be removed from the comparison. If so, information from additional location histories for other users involving the item being found may be necessary to accurately determine the location of the item. Where the first indication and/or the second indication includes a respective first and/or second time of finding the first type of item, the determination of the location of the first type of item can be further based on the first and/or second time of finding the item type. The first and/or second pluralities of locations may be further based on the respective first and/or second times of finding by (i) including only locations in the respective pluralities that were visited by the respective first and/or second mobile device within a threshold period of time from the respective first and/or second times of finding and/or (ii) including only locations and times in the respective pluralities at which the respective first and/or second mobile device was determined by the respective first and/or second mobile device to be stationary, substantially stationary, or making movements consistent with acquiring the first type of item. As previously indicated, in some embodiments, locations in the first plurality of locations may be weighted according to their temporal proximity to the times of finding, such that each location of the first plurality of locations is weighted based on the time elapsing between the first mobile device being present at the location and the first time of finding, wherein the weight of a location increases as the time elapsing is reduced. Similar weighting can be performed for the second plurality of locations with respect to the second mobile device and second time of finding. As indicated elsewhere herein, once a location of the first type of item is determined, embodiments may provide for a computer system creating information that associates the first type of item to a location on a map or an interior layout of a particular store, based on the determined location. Moreover, in some embodiments, a computer system can receive a request for the location of the first type of item and respond by providing the location of the first type of item, where the provided location is the determined location. A location may be provided in relative terms, where the provided location comprises a reference location and a location relative to the reference location. In some embodiments, the computer system may further be equipped to provide a route to the provided location. In some embodiments, a computer system may determine a location for a second type of item, may determine that the first type of item and the second type of item are part of a category and may determine an area corresponding to the category, based on the determined location of the first type of item and the determined location of the second type of item. In some embodiments, the first location history and/or the second location history includes a reference location, where the reference location corresponds to the location of the first type of item, a location of a second type of item or a known location (e.g. the location of known place such as the location of the entrance, a particular elevator or a certain checkout point in a store). In these embodiments, the determination of the first type of item at block 750 may be based in part on the reference location. Means for performing block 750 may include a server system, such as server system 530 of FIG. 6. For example, block 750 may be performed by correlation engine 531 which could be implemented using software, firmware, and hardware. Means for performing block 750 may include various computerized components, such as one or more instances of components of computer system 1100 of FIG. 12.

### Location Assistance Embodiment

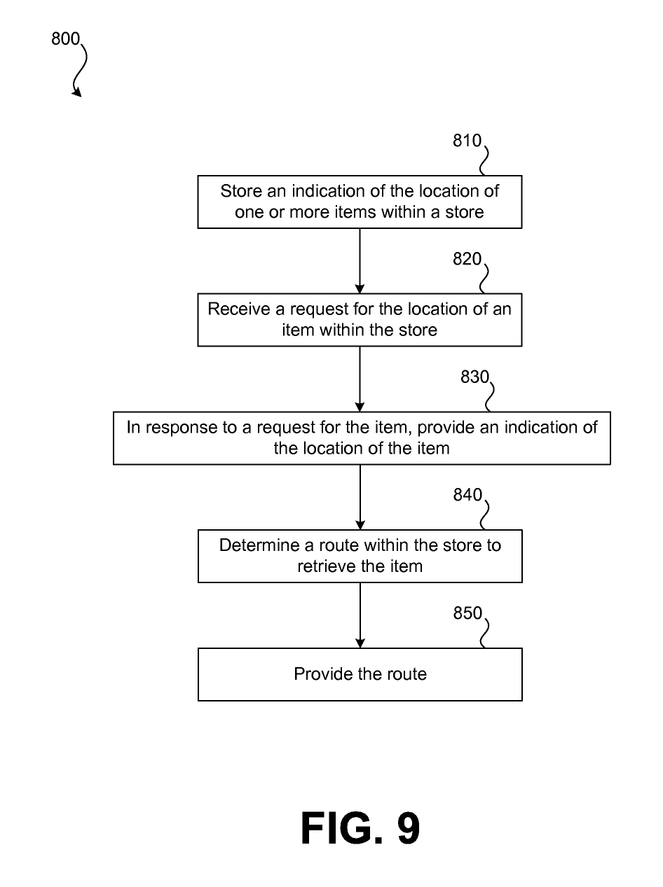

While the method of FIG. 8 is focused on determining the location of an item, method 800 of FIG. 9 is focused on providing a user with an indication of where an item is located. Therefore, FIG. 9 illustrates an embodiment of a method for providing a location of an item. Method 800 may be performed by system 500 of FIG. 6 or some other system (e.g. a locating system) configured to determine the location of items and, possibly, provide such locations to users. Each block of method 800 may be performed by a remotely accessible computer system, such as server system 530 of FIG. 6 or server 50 of FIG. 1. Such a server system may be in communication with multiple mobile devices of multiple users. In some embodiments, rather than each block being performed by a remote computer sever, a mobile device may operate in a standalone mode, as detailed previously, and perform each block of method 800. Computer system 1100 of FIG. 12 may be used to perform each block of method 800. Accordingly, means for performing each block of method 800 can include one or more instances of computerized hardware, such as some or all of the components detailed in relation to system 500 of FIG. 6, mobile device 600 of FIG. 7, and computer system 1100 of FIG. 12.

Method 800 could be invoked manually by a user (e.g., when entering a certain store) or could be set up by a user to activate automatically when the location of the user coincides with certain designated places (e.g., certain stores). A locating system could also be provided in association with a certain social network to share and receive data by subscribing to a private crowdsourcing service. A locating system may also give additional product information—e.g., a user can find when was the last time a product was found or not found (by the user), how popular certain items are (e.g., certain brands of items) and whether alternative similar items may be available when a preferred item is not found. This additional information could require additional system intelligence (e.g., knowledge of relationships between similar items) which might be built up, in whole or in part, by allowing users to enter replacement items when a preferred item was not found.

At block 810, an indication of the location of one or more items within a store (or other form of location) may be stored. To determine such locations, method 700 may be used as previously detailed.

At block 820, a request for the location of an item may be received. Such a request may be in response to a user inputting an item to his mobile device that the user desires to acquire or otherwise find. The request may or may not indicate the store (or other area or place) at which the user desires to locate the item. For instance, the store (or other area or place) may be selected based on a location of the user or where the user usually shops. In some embodiments, the user may specify a particular store. In some embodiments, the store (or other area or place) may be selected based on one or more items indicated by the user as needing to be found. Means for performing block 820 may include lookup engine 532 of FIG. 6, which may access item/store database 535 to determine a location of the item within the store (or other area or place) at which the user is or will be shopping (or is or will be looking for items). Means for performing block 820 further include one or more computerized components of computer system 1100 of FIG. 12.

In response to the request received at block 820, an indication of the location of the item may be provided to the user's mobile device at block 830. This location of the item may have been determined using the crowdsourcing of method 700 of FIG. 8. The location of the item indicated to the user may be in the form of a location superimposed on a map of the store (or other area or place) and/or turn-by-turn directions. Means for performing block 830 may include server system 530 of FIG. 6, which may communicate with a mobile device via one or more networks such as network 520.

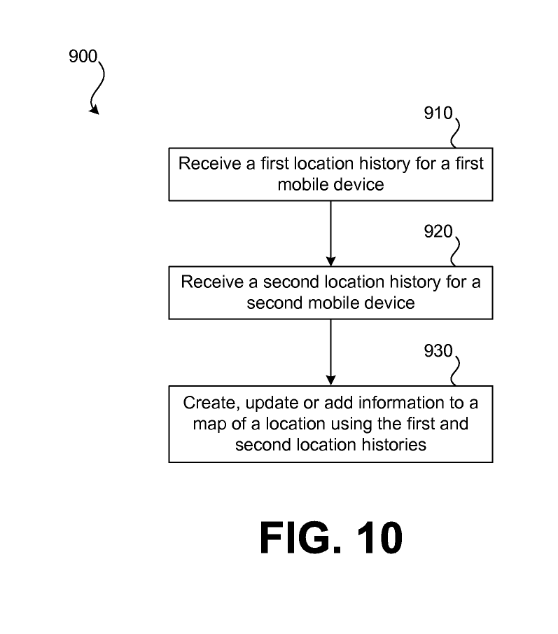

In some embodiments, such as embodiments in which the user desires to locate multiple items within the store, a route that leads the user from item to item may be useful. At block 840, a route within the store to retrieve the item and any other items that have a known location that are also desired to be found by the user may be determined. The route may be at least partially based on the internal configuration of the store, such as where aisles, entrances, exits, product stands, freezer cases, and displays are located. The location of such obstacles may be obtained through a map of the store being stored to map database 536 and/or may be determined in accordance with method 900 of FIG. 10. The route should be configured such that the user is not expected to pass through shelves and other obstacles. As previously detailed, the route may be optimized to minimize the distance traveled by the user, the amount of time the user may be carrying heavy items, the amount of time that refrigerated items are in the user's possession, etc. Means for performing block 840 may include route engine 533 of FIG. 6. Route engine 533 may be configured to access item/store database 535 for the location of items within the store and map database 536 to access a map of the store. Means for performing block 840 can further include one or more computerized components of computer system 1100 of FIG. 12.

At block 850, the route may be provided to the user. This may involve the route being transmitted to the user's mobile device and presented to the user via the mobile device's display. Means for performing block 850 can include a server system, one or more networks, and a mobile device; such components may be computerized and include one or more components of computer system 1100 of FIG. 12.

### Creation of Mapping Data

In order to obtain a map of the interior of a store, it may be necessary for a map to be created or otherwise obtained. In some instances, a store operator may provide an accurate map of the store. In other embodiments, a map could be created by having a trusted user walk around various obstacles to define the location of the obstacles in a location history. Users' location histories, which may be gathered as part of method 700 of FIG. 8, may also be used to create a map for a location. FIG. 10 illustrates an embodiment of a method 900 for creating or updating a map of a store or other area or place using multiple location histories. Method 900 may be performed by system 500 of FIG. 6 or some other system (e.g. a locating system) configured to map a location. Each block of method 900 may be performed by a remotely accessible computer system, such as server system 530 of FIG. 6. Such a server system may be in communication with multiple mobile devices of multiple users. In some embodiments, rather than each block being performed by a remote computer sever, a mobile device may operate in a standalone mode, as detailed previously, and perform each block of method 900. Computer system 1100 of FIG. 12 may be used to perform each block of method 900. Accordingly, means for performing each block of method 900 can include one or more instances of computerized hardware, such as some or all of the components detailed in relation to system 500 of FIG. 6, mobile device 600 of FIG. 7, and computer system 1100 of FIG. 12.

At block 910, a first location history for a first mobile device may be received. This first location history may include discrete points or a continuous route which a user has taken with his mobile device through a store. Referring to method 700, the location history received at block 910 may represent a same location history that was received at block 710. Therefore, the first location history may be gathered by a user's mobile device and transmitted to a remote server system after the user has left the store or while the user is within the store. Similarly, at block 920, a second location history for a second mobile device may be received for the same store. (In some embodiments, the second mobile device may be the first mobile device during a different visit by the user to the store). This second location history may include discrete points or a continuous route which a user has taken with his mobile device through the store. Referring to method 700, the location history received at block 920 may represent a same location history that was received at block 730. Therefore, the second location history may be gathered by a user's mobile device and transmitted to a remote server system after the user has left the store or while the user is within the store. Means for performing blocks 910 and 920 can include one or more mobile devices, one or more networks for communication, and a server system. While method 900 discloses two location histories being gathered for mobile devices, it should be understood that many more location histories may be used to create an accurate map of a store (or other area or place). Means for performing blocks 910 and 920 may include one or more mobile devices, one or more communication networks, and a remote server. Means for performing blocks 910 and 920 can further include one or more computerized components of computer system 1100 of FIG. 12.

For instance, referring to FIG. 4, the two illustrated location histories 110 may be received. These location histories are indicative of where two users have travelled within a store. It may be assumed (e.g. by a locating system) that a user did not go through, climb over, or otherwise move where an obstacle is present. For instance, both users moved around product shelves 140 in the example of FIG. 4. The location of product shelves 140 may be ascertained by the system based on regions within the store where no user locations occur or tend to occur. For instance, none of location histories 110 may overlap product shelves 140. To accurately determine the location and/or shape of product shelves 140, many location histories may be analyzed by the locating system to determine an approximate shape and location of product shelves 140.

At block 930, as previously indicated, information that associates a type of item to a location on an existing map of the store (or other area or place) can be created. This information can be provided as semantic information or as an annotation to an existing map. Additionally or alternatively, a new map may be created or an existing map may be verified and corrected or updated (e.g. if an internal layout of store has changed) by analyzing regions within the store (or other area or place) where the users were able to travel and regions where users did not travel. If a predefined number of location histories, such as a hundred or a thousand, have not passed through a location, it may be assumed that an obstacle is present. Any map created or updated at block 930 may indicate the areas covered by obstacles or other inaccessible regions such that all or most location histories do not pass through any obstacles. Areas or volumes of at least a predefined size through which no or almost no location histories pass may be determined to be an obstacle, such as product shelving. For instance, the location of product shelving 140 of FIG. 4 may be determined based on the first location history and the second location history. Means for performing block 930 can include mapping engine 534 of FIG. 6. Mapping engine 534 may receive location histories from one or more mobile devices and create, update or add information to a map that is stored to map database 536. Means for performing block 930 can further include one or more computerized components of computer system 1100 of FIG. 12.

In some embodiments, particular types of location within the store may be identified based on when the user visited the location. For instance, the last location at which a user is stationary or nearly stationary for at least some threshold period of time (e.g. 10 to 30 seconds) may typically be a cashier. A checkout region of a store (e.g. checkout region 150 in the examples of FIGS. 2-4) may be determined based on a location where users tend to pause for at least a threshold period of time before exiting the store. An entrance and/or exit of a store (e.g. entrance and exit 160 in the examples of FIGS. 2-4) may be ascertained by a locating system based on where location histories begin and/or end within the store. A locating system may determine the boundaries of a store and thus when a user has entered or exited a store from existing map data (e.g. a satellite image that provides enough resolution to delineate the perimeter of a store building) and/or from confirmations provided by users that they are within or outside of a store. For example, a locating system may not provide directions to items in a store for a user until the user has confirmed that they are physically inside the store. Alternatively, or in addition, a locating system may make use of the fact that any building such as a store will have a small number of entrances and exits. By verifying that all user location histories pass through a small number of small areas (where each small area corresponds to an entrance and/or exit), a locating system may determine that each of the small areas corresponds to an entrance and/or an exit. Furthermore, if users always start looking for a first item on a list after passing through an assumed store entrance and always finish looking for a last item on a list before passing through an assumed exit to a store, a locating system may validate assumed entrances and exits to a store. If the general direction of users movements in passing through a store entrance or exit is further recorded (e.g. a general direction of west to east in passing through an entrance and a general direction of east to west in passing through an exit), a locating system may determine when a user is inside a store (due to having passed through an entrance in the general direction previously recorded for the entrance) and when a user has left the store (due to having passed through an exit in the general direction recorded for the exit) even when an entrance and exit may occupy the same small area or space.

The map created at block 930 in FIG. 10 may be refined as additional location histories are collected from one or more users. The map created may be provided to a mobile device of a user if the user will be locating an item within the store. The location of the item within the store may be indicated on the map. This map may also be used for determining a route for a user to travel from item to item. Such a map may be similar to the store maps of FIGS. 2-4. This map may be presented to a user via a mobile device to indicate where items desired by the user are located. A suggested route may also be indicated. The suggested route, as previously detailed, may be determined by a locating system to be the shortest and/or an otherwise most efficient route.

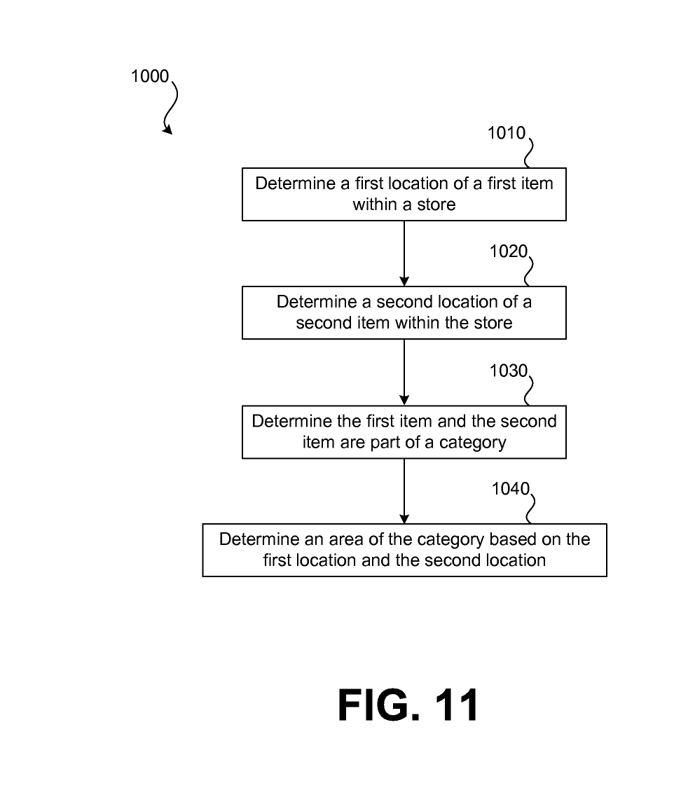

FIG. 11 illustrates an embodiment of a method 1000 for determining category locations based on item locations. Method 1000 may be performed by system 500 of FIG. 6 or some other system (e.g. a locating system) configured to map a location. Each block of method 1000 may be performed by a remotely accessible computer system, such as server system 530 of FIG. 6. Such a server system may be in communication with multiple mobile devices of multiple users. In some embodiments, rather than each block being performed by a remote computer sever, a mobile device may operate in a standalone mode, as detailed previously, and perform each block of method 1000. Computer system 1100 of FIG. 12 may be used to perform each block of method 1000. Accordingly, means for performing each block of method 1000 can include one or more instances of computerized hardware, such as some or all of the components detailed in relation to system 500 of FIG. 6, mobile device 600 of FIG. 7, and computer system 1100 of FIG. 12.

At block 1010, a first location of a first item or type of first item may be determined within a store. Block 1010 may correspond to block 750 of method 700. By way of example, the first item may be a type of cereal, such as cornflakes. At block 1020, a second location of a second item or type of second item may be determined within a store. Block 1020 may correspond to block 750 of method 700 (performed for a different item within the same store). By way of example, the second item may also be a type of cereal, such as shredded wheat.

At block 1030, it may be determined that the first item and the second item are part of the same category. The server system performing method 1000 may have been configured with information defining various specific items that are categorized into various general categories. For example, information may be configured for specific types of fruits and vegetables and associated with the general categories of fruits and vegetables, respectively. Similarly, information may be configured for specific types of cereal and associated with the general category of cereals and/or breakfast foods. Alternatively, the server system performing method 1000 may determine from user input that certain specific item names belong to certain categories of item. For example, when users first enter a specific item name and then a name of a general category (or vice versa) when asked by the server system to elaborate on the first entered name, a server system can associate the two names. If the association is repeated and extended due to input from other users, a server system may recognize that certain item names correspond to item categories due to being associated with some or many other item names. At block 1030, the categories stored by the server system may be used to determine that the first and second items are part of the same category. Referring to the previous example, cornflakes and shredded wheat are both types of serial.

At block 1040, an area within the store may be determined to correspond to the category determined at block 1030 based on the first location of the first item and the second location of the second item. For example, the area may comprise the first and second locations or may enclose the first and second locations. Referring to the previous example, a general region within the store associated with cereals may be determined based on the location determined for cornflakes and the location determined for shredded wheat. While this example involves only 2 types of cereal, it should be understood that such a determination may be based on the location of many more types of cereal and/or other types of breakfast foods. In some embodiments, if a particular item is found within an aisle of the store, it may be assumed that the aisle of the store corresponds to a general category of item corresponding to the particular item.

Once a region within a store has been determined for a particular category of item, the category's region can be used to provide a user with a general location for any specific item that is part of this category, if the item's specific location is unknown. Further, a user may be able to request the location for the general category without inputting a specific item belonging to this category.

In an aspect, a locating system may be used with coarse location granularity to locate shops, restaurants, office buildings, hotels and other places in a town or city when such information is otherwise lacking. For example, an internet service or social network could make use of its users to gather such data and provide it to other users.

In addition to handling categories, a locating system that locates items in multiple areas and/or at different levels of location accuracy, may make use of context information prior to providing directions to a user to items or places of interest. For example, a locating system may have data on the locations of certain places and items in a certain town, one or more shopping malls in the town and in some or all stores within each shopping mall. If a user happens to be nearby to a particular gardening-related store in a particular shopping mall in the town and asks the locating system to provide directions to “garden tools”, the locating system could (i) confine directions to the nearby gardening store, (ii) provide directions to other stores in the mall that may have garden tools, (iii) provide directions involving other stores outside the mall or (iv) provide directions involving any stores (in the mall or elsewhere) that use the term “garden tools” as part of their name—e.g., as in “Garden Tools Outlet” or “Garden Tools and Furniture”. These different alternatives may mean that a locating system must obtain additional information in order to know which alternative to use in providing directions to a user—e.g. whether to use alternative (i), (ii), (iii) or (iv) in the previous example regarding garden tools. The additional information could be obtained by (a) explicit input by the user, (b) a locating system query to the user followed by a user response or (c) conventions previously established by a locating system for the particular user or for users in general which may prioritize different contexts (e.g. may prioritize among alternatives (i), (ii), (iii) and (iv) in the previous example) according to a user's location. For example, in the case of alternative (c) above, a locating system may discover that a particular user or users in general prefer to be directed to a requested item within the smallest area that the user is currently located in or is nearby to that contains or may contain the requested item. The discovery may occur as a result of information received when alternatives (a) and (b) are used or may occur as a result of users rejecting directions when provided using other conventions (such as involving directing users to more distant stores).

A locating system could be further used in a venue to map and provide location information at a much finer level of detail than known initially. For example, the owner or operator of a shopping mall may know the layout of the shopping mall including the locations and general layout of each store in the mall. However, the owner or operator may not know the exact floor plan of each store (e.g., which may periodically change) or the locations within each store of particular groups of items and individual items—e.g., such as where cosmetics or jewelry may be located exactly inside a large department store. By using a locating system to gather such information, the operator or owner of a shopping mall may be able to provide both enhanced map data to users (e.g., showing where major groups of items may be exactly found in each store) and the ability to guide users to particular items. Furthermore, these directions may be given when a user enters the shopping mall as well as when a user enters a particular store. The same capability may apply to other types of venue such as museums, art galleries, hospitals, airports.

### Example Computer System

FIG. 12 represents an example of a computer system. A computer system as illustrated in FIG. 12 may be incorporated as part of the previously described computerized devices, such as the server system 530 of FIG. 6, server 50 of FIG. 1, mobile devices 10 of FIG. 1 and mobile device 600 of FIG. 7. FIG. 12 provides a schematic illustration of one embodiment of a computer system 1100 that can perform various steps of the methods provided by various embodiments. It should be noted that FIG. 12 is meant only to provide a generalized illustration of various components, any or all of which may be utilized as appropriate. FIG. 12, therefore, broadly illustrates how individual system elements may be implemented in a relatively separated or relatively more integrated manner.

The computer system 1100 is shown comprising hardware elements that can be electrically coupled via a bus 1105 (or may otherwise be in communication, as appropriate). The hardware elements may include one or more processors 1110, including without limitation one or more general-purpose processors and/or one or more special-purpose processors (such as digital signal processing chips, graphics acceleration processors, video decoders, and/or the like); one or more input devices 1115, which can include without limitation a mouse, a keyboard, remote control, a touchscreen, a microphone and/or the like; and one or more output devices 1120, which can include without limitation a display device, a printer, a loudspeaker and/or the like.

The computer system 1100 may further include (and/or be in communication with) one or more non-transitory storage devices 1125, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 1100 might also include a communications subsystem 1130, which can include without limitation a modem, a network card (wireless or wired), an infrared communication device, a wireless communication device, and/or a chipset (such as a Bluetooth device, an 802.11 device, a WiFi device, a WiMax device, cellular communication device, etc.), and/or the like. The communications subsystem 1130 may permit data to be exchanged with a network (such as the network 520 in FIG. 6, to name one example), other computer systems, and/or any other devices described herein. In many embodiments, the computer system 1100 will further comprise a working memory 1135, which can include a RAM or ROM device, as described above.

The computer system 1100 also can comprise software elements, shown as being currently located within the working memory 1135, including an operating system 1140, device drivers, executable libraries, and/or other code, such as one or more application programs 1145, which may comprise computer programs provided by various embodiments, and/or may be designed to implement methods, and/or configure systems, provided by other embodiments, as described herein. In an embodiment, one or more of application programs 1145 may be or may support applications that support a locating system in the case that computer system 1100 corresponds to a mobile device such as mobile device 10 in FIG. 1 or mobile device 600 in FIG. 7. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 1125 described above. In some cases, the storage medium might be incorporated within a computer system, such as computer system 1100. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 1100 and/or might take the form of source and/or installable code, which, upon compilation and/or installation on the computer system 1100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1100) to perform methods in accordance with various embodiments of the invention. According to a set of embodiments, some or all of the procedures of such methods are performed by the computer system 1100 in response to processor 1110 executing one or more sequences of one or more instructions (which might be incorporated into the operating system 1140 and/or other code, such as an application program 1145) contained in the working memory 1135. Such instructions may be read into the working memory 1135 from another computer-readable medium, such as one or more of the non-transitory storage device(s) 1125. Merely by way of example, execution of the sequences of instructions contained in the working memory 1135 might cause the processor(s) 1110 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 1100, various computer-readable media might be involved in providing instructions/code to processor(s) 1110 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 1125. Volatile media include, without limitation, dynamic memory, such as the working memory 1135.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1110 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1100.

The communications subsystem 1130 (and/or components thereof) generally will receive signals, and the bus 1105 then might carry the signals (and/or the data, instructions, etc. carried by the signals) to the working memory 1135, from which the processor(s) 1110 retrieves and executes the instructions. The instructions received by the working memory 1135 may optionally be stored on a non-transitory storage device 1125 either before or after execution by the processor(s) 1110.

It should further be understood that the components of computer system 1100 can be distributed across a network. For example, some processing may be performed in one location using a first processor while other processing may be performed by another processor remote from the first processor. Other components of computer system 1100 may be similarly distributed. Computer system 1100 may therefore be interpreted as a distributed computing system that performs processing in multiple locations. In some instances, computer system 1100 may be interpreted as a single computing device, such as a distinct laptop, desktop computer, mobile device, or the like, depending on the context.

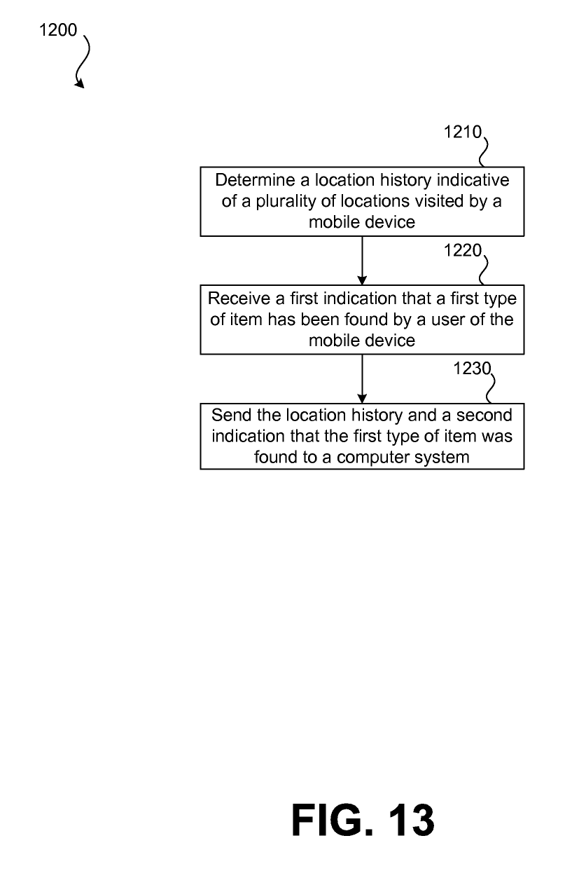

FIG. 13 represents an embodiment of a method 1200 for locating an item at a mobile device. Method 1200 may be performed by a mobile device (such as a mobile device 10 of FIG. 1, 400 of FIG. 5, 510 of FIG. 6, and 600 of FIG. 7, or by some other apparatus configured to determine the locations of items and, possibly, provide such locations to users. Each block of method 1200 may be performed by a mobile device in communication with a remotely-accessible computer system, such as server system 530 of FIG. 6 or server 50 of FIG. 1. Such a server system may be in communication with multiple mobile devices of multiple users—for example, with mobile devices 10 of FIG. 1, mobile devices 510 of FIG. 6 or mobile device 600 of FIG. 7. The mobile device 600 of FIG. 7 may be used to perform each block of method 1200. Accordingly, means for performing each block of method 1200 can include any combination of hardware and/or software, such as some or all of the components detailed in relation to mobile device 600 of FIG. 7.

At block 1210, a location history indicative of a plurality of locations visited by the mobile device is determined. As indicated previously, sensors on the mobile device and/or measurement by the mobile device of signals received from GNSS satellites and/or terrestrial APs and/or base stations may be used to determine a location for the mobile device at any time and may thus determine when a user of the mobile device was at various locations. Thus, in some embodiments, the location history may include times corresponding to each of the plurality of locations, indicating when the mobile device (and thus typically the user of the mobile device) was at a particular location. The location history of the mobile device may overlap to various degrees with location histories of other mobile devices.

At block 1220, an indication that a first type of item has been found by a user of the mobile device is received. As previously discussed, such an indication can come in various forms. In some instances, for example, the user may indicate the first type of item has been found using a user interface (e.g., touch, audio, visual, and/or motion input, and the like). Depending on circumstances, desired functionality, and/or other factors, the time between when the indication is received and when the item was actually found may vary.

At block 1230 the location history and a second indication that the type of item was found are sent to a computer system. This second indication can be distinct from the location history and/or embedded within the location history. In some embodiments, the second indication can be a time at which the first indication at block 1220 was received and/or a location in the first plurality of locations corresponding to a location of the mobile device when the first indication was received. In some embodiments, the plurality of locations in the location history can include locations visited by the mobile device within a threshold period of time from the time the first indication at block 1220 was received, and/or locations and times at which the mobile device was determined by the mobile device to be stationary, substantially stationary, or making movements consistent with acquiring the first type of item. As discussed previously, the location history (or the plurality of locations) can include weightings of one or more locations that indicate a likelihood that each of the one or more locations is a location at which the first type of item was found. In some embodiments, the shorter the amount of time that has elapsed between the user providing an indication of the item being located and when the mobile device was present at a location of the location history, the more likely the location may be considered to correspond to the true location of the item. Thus, a greater weight may be assigned to a location associated with a shorter elapsed time. Other embodiments may weight locations differently. The weight of each location in the location history can be included in and/or with the location history sent to the computer system. In some embodiments an indication of a particular store (e.g., the name and/or address of the store) may also be sent to the computer system. The computer system may have information indicative of where types of items are. And thus, embodiments may include the mobile device sending a request for the location of the first type of item to the computer system (e.g. to assist the user of the mobile device to find the first type of item), receiving at least one of a location of the first type of item or a route for the first type of item from the computer system, and providing directions to the user of the mobile device (e.g., via a display, audio output, or the like, which may depend on capabilities of the mobile device) based on at least one of the location and the route. As indicated previously herein, reference locations may be used in certain embodiments. For example, the location of the first type of item provided to the mobile device by the computer system may include a reference location and a location relative to the reference location. Additionally or alternatively, the location history determined at block 1210 can include a reference location, where the reference location corresponds to at least one of the location of the mobile device when the first indication is received at block 1220, the location of the mobile device when an indication that a second type of item was found by the user of the mobile device is received or an indication that a known location (e.g. a location of an entrance to a store or a certain elevator or check out point in a store) was found by the user is received. Means for performing blocks 1210, 1220 and 1230 may include various computerized components, such as the location sensor(s) 620, communication interface(s) 630, processing module 610, and/or databases 660, 670, 680 of the mobile device 600 of FIG. 7.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for locating an item, the method comprising:
receiving, by a computer system, a first location history indicative of a first plurality of locations visited by a first mobile device;
receiving, by the computer system, from the first mobile device, a first indication of a first type of item being found;
receiving, by the computer system, a second location history indicative of a second plurality of locations visited by a second mobile device;
receiving, by the computer system, from the second mobile device, a second indication of the first type of item being found; and
determining, by the computer system, a location of the first type of item based on the first plurality of locations and the second plurality of locations.

2. The method of claim 1, wherein the respective first and second indications each comprise a respective first and second time of finding of the first type of item and wherein determining the location of the first type of item is based additionally on the first and second times of finding.

3. The method of claim 2, wherein the respective first and second pluralities of locations each comprise at least one of:
locations visited by the respective first and second mobile device within a threshold period of time from the respective first and second times of finding, or
locations and times at which the respective first and second mobile device was determined by the respective first and second mobile device to be stationary, substantially stationary, or making movements consistent with acquiring the first type of item.

4. The method of claim 2, further comprising:
weighting each location of the first plurality of locations based on the time elapsing between the first mobile device being present at the location and the first time of finding, wherein the weight of a location increases as the time elapsing is reduced;
weighting each location of the second plurality of locations based on the time elapsing between the second mobile device being present at the location and the second time of finding, wherein the weight of a location increases as the time elapsing is reduced; and
determining the location of the item based on the weighting.

5. The method of claim 1, wherein:
the first indication comprises a location in the first plurality of locations corresponding to finding the first type of item; and
the second indication comprises a location in the second plurality of locations corresponding to finding the first type of item.

6. The method of claim 1, further comprising:
determining, by the computer system, that the first location history and the second location history are associated with a particular store.

7. The method of claim 6, further comprising:
creating, by the computer system, information that associates the first type of item to a location on a map of an interior layout of the particular store based on the determined location of the first type of item.

8. The method of claim 1, further comprising:
receiving a request for the location of the first type of item; and
providing the location of the first type of item, wherein the provided location is the determined location.

9. The method of claim 8, wherein the provided location comprises a reference location and a location relative to the reference location.

10. The method of claim 8, further comprising determining a route to retrieve the first type of item; and
providing the route.

11. The method of claim 1, further comprising:
determining, by the computer system, a location of a second type of item;
determining, by the computer system, the first type of item and the second type of item are part of a category; and
determining an area corresponding to the category, based on the location of the first type of item and the location of the second type of item.

12. The method of claim 1, wherein the first location history comprises a reference location, wherein the reference location corresponds to at least one of the location of the first type of item, a location of a second type of item or a known location.

13. The method of claim 12, wherein determining the location of the first type of item is based in part on the reference location.

14. A method for locating an item at a mobile device, the method comprising:
determining a location history for the mobile device indicative of a plurality of locations visited by the mobile device;
receiving a first indication that a first type of item has been found by a user of the mobile device;
sending the location history and a second indication that the first type of item was found to a computer system.

15. The method of claim 14, wherein the second indication comprises a time the first indication was received.

16. The method of claim 15, wherein the plurality of locations comprise at least one of:
locations visited by the mobile device within a threshold period of time from the time the first indication was received, or
locations and times at which the mobile device was determined by the mobile device to be stationary, substantially stationary, or making movements consistent with acquiring the first type of item.

17. The method of claim 15, further comprising:
weighting each location of the plurality of locations based on the time elapsing between the mobile device being present at the location and the time the first indication was received, wherein the weight of a location increases as the time elapsing is reduced; and
including the weight of each location in the location history sent to the computer system.

18. The method of claim 14, wherein:
the second indication comprises a location in the plurality of locations corresponding to a location of the mobile device when the first indication was received.

19. The method of claim 14, further comprising:
sending an indication of a particular store to the computer system.

20. The method of claim 14, further comprising:
sending a request for the location of the first type of item to the computer system;
receiving at least one of a location of the first type of item or a route for the first type of item from the computer system; and
providing directions to the user of the mobile device based on at least one of the location and the route.

21. The method of claim 20, wherein the location of the first type of item comprises a reference location and a location relative to the reference location.

22. The method of claim 14, wherein the location history comprises a reference location, wherein the reference location corresponds to at least one of the location of the mobile device when the first indication is received, the location of the mobile device when an indication that a second type of item was found is received or an indication that a known location was found is received.

23. A server comprising:
a communication interface configured to:
receive a first location history indicative of a first plurality of locations visited by a first mobile device;
receive, from the first mobile device, a first indication of a first type of item being found;
receive a second location history indicative of a second plurality of locations visited by a second mobile device;
receive, from the second mobile device, a second indication of the first type of item being found; and
a processor communicatively coupled with the communication interface and configured to determine a location of the first type of item based on the first plurality of locations and the second plurality of locations.

24. The server of claim 23, wherein the processor is configured to determine the location of the first type of item based additionally on first and second times of finding the first type of item, and wherein the first and second times of finding are included in the respective first and second indications.

25. The server of claim 24, wherein the processor is configured to:
weight each location of the first plurality of locations based on the time elapsing between the first mobile device being present at the location and the first time of finding, wherein the weight of a location increases as the time elapsing is reduced;
weight each location of the second plurality of locations based on the time elapsing between the second mobile device being present at the location and the second time of finding, wherein the weight of a location increases as the time elapsing is reduced; and
determine the location of the item based on the weighting.

26. The server of claim 23, wherein the processor is configured to determine that the first location history and the second location history are associated with a particular store.

27. The server of claim 23, wherein:
the communication interface is further configured to receive a request for the location of the first type of item; and
the processing unit is further configured to cause the server to provide the location of the first type of item, wherein the provided location is the determined location.

28. A mobile device comprising:
a processor configured to determine a location history for the mobile device indicative of a plurality of locations visited by the mobile device;
configured to receive a first indication that a first type of item has been found by a user of the mobile device; and
a communication interface configured to send the location history and a second indication that the first type of item was found to a computer system.

29. The mobile device of claim 28, wherein the processor is configured to:
weight each location of the plurality of locations based on the time elapsing between the mobile device being present at the location and the time the first indication was received, wherein the weight of a location increases as the time elapsing is reduced; and
include the weight of each location in the location history sent to the computer system.

30. The mobile device of claim 28, wherein the processor is configured to cause the mobile device to send, via the communication interface, an indication of a particular store to the computer system.

31. The mobile device of claim 28, wherein the processor is configured to cause the mobile device to:
send, via the communication interface, a request for the location of the first type of item to the computer system;
receive, via the communication interface, at least one of a location of the first type of item or a route for the first type of item from the computer system; and
provide directions to the user of the mobile device based on at least one of the location and the route.

32. An apparatus comprising:
means for receiving a first location history indicative of a first plurality of locations visited by a first mobile device;
means for receiving, from the first mobile device, a first indication of a first type of item being found;
means for receiving a second location history indicative of a second plurality of locations visited by a second mobile device;
means for receiving, from the second mobile device, a second indication of the first type of item being found; and
means for determining a location of the first type of item based on the first plurality of locations and the second plurality of locations.

33. The apparatus of claim 32, wherein the means for determining the location of the first type of item are configured to base the determination on first and second times of finding the first type of item when the first and second times of finding are included in the respective first and second indications.

34. The apparatus of claim 33, further comprising:
means for weighting each location of the first plurality of locations based on the time elapsing between the first mobile device being present at the location and the first time of finding, wherein the weight of a location increases as the time elapsing is reduced;
means for weighting each location of the second plurality of locations based on the time elapsing between the second mobile device being present at the location and the second time of finding, wherein the weight of a location increases as the time elapsing is reduced; and
means for determining the location of the item based on the weighting.

35. The apparatus of claim 32, further comprising means for determining that the first location history and the second location history are associated with a particular store.

36. The apparatus of claim 23, further comprising:
means for receiving a request for the location of the first type of item; and
means for providing the location of the first type of item, wherein the provided location is the determined location.

37. An apparatus comprising:
means for determining a location history for a mobile device indicative of a plurality of locations visited by the mobile device;
means for receiving a first indication that a first type of item has been found by a user of the mobile device; and
means for sending the location history and a second indication that the first type of item was found to a computer system.

38. The apparatus of claim 37, further comprising:
means for weighting each location of the plurality of locations based on the time elapsing between the mobile device being present at the location and the time the first indication was received, wherein the weight of a location increases as the time elapsing is reduced; and
means for including the weight of each location in the location history sent to the computer system.

39. The apparatus of claim 37, further comprising means for sending an indication of a particular store to the computer system.

40. The apparatus of claim 37, further comprising means for:
sending a request for the location of the first type of item to the computer system;
receiving at least one of a location of the first type of item or a route for the first type of item from the computer system; and
providing directions to the user of the mobile device based on at least one of the location and the route.
